(19) United States
(12) Patent Application Publication
(10) Pub. No.: US 2026/0044207 A1
(43) Pub. Date: Feb. 12, 2026

(54) GAUSSIAN-BASED METHOD FOR GAZE ZONE DETECTION

(71) Applicant: QUALCOMM Incorporated, San Diego, CA (US)

(72) Inventors: Lei WANG, San Diego, CA (US); Junkang ZHANG, San Diego, CA (US); Zhen WANG, San Diego, CA (US); Chun-Ting HUANG, San Diego, CA (US); Ning BI, San Diego, CA (US)

(21) Appl. No.: 18/799,843

(22) Filed: Aug. 9, 2024

(51) Int. Cl. G06F 3/01; G06T 7/70; G06T 17/00

(52) U.S. Cl. CPC G06F 3/013; G06T 7/70; G06T 17/00

(57) ABSTRACT

Certain aspects of the present disclosure provide techniques for gaze zone detection. A method generally includes estimating a first gaze direction of a user based on at least one or more first two-dimensional (2D) images of a face of the user, wherein the first gaze direction is represented as a first yaw angle and a first pitch angle in a camera coordinate system; and associating the first gaze direction of the user with a first gaze zone among a plurality of gaze zones based on: the first yaw angle; the first pitch angle; and a first Gaussian distribution of the first gaze zone, wherein the first Gaussian distribution is based on a plurality of gaze directions, of a plurality of users, associated with the first gaze zone.

### INTRODUCTION

### Field of the Disclosure

Aspects of the present disclosure relate to techniques for gaze estimation.

### Description of Related Art

Eye gaze (simply referred to herein as “gaze”) plays an important role in identifying a user's point of interest in terms of direction, location, attention, and/or interactions. Gaze estimation is a frequently used approach to determine user gaze, or simply, predict where a user is looking, either as gaze directions or as points of regard in space (e.g., such as on a computer screen, a handheld device, along the horizon, etc.). As used herein, gaze direction of a user may refer to a vector positioned along a visual axis of the user, pointing from the fovea of the user's eye through the center of the user's pupil to a gazed-at spot/point, commonly referred to as a “fixation point.” The visual axis, also commonly referred to as the “foveal-fixation axis,” may be an imaginary line that connects the fixation point, the fovea, and the corneal center of the eye.

Gaze direction may be a product of two contributing factors, including (1) head pose and (2) eye location of a user. Head pose of a user may refer to the orientation of the user's head in three-dimensional (3D) space. The orientation of the user's head may be represented as yaw, pitch, and roll angles. The pitch angle, yaw angle, and roll angle may represent an amount of head rotation of the user along an X-axis, Y-axis, and Z-axis, respectively. In case of head movement, the yaw angle may correspond to the user's head looking left or right and the pitch angle may correspond to the user' head looking up or down. Further, the roll angle may correspond to the user's head nodding left or right. Eye location may refer to the center of the 3D locations of the user's eyes relative to the head of the user.

Some gaze estimation technology may estimate and track a user's gaze direction using an image sensor, such as a user-facing camera equipped with infrared light-emitting diode(s) (LED(s)) and/or laser(s) (e.g., infrared light may help to create reflections in the eyes, making them easier to detect and track) to detect a user's face and/or head and capture information about the user's head position, head pose, and eye movements, to name a few. For example, the gaze estimation technology may capture detailed images of the user's head and/or eyes and use the images to simultaneously perform two tasks: localization of the user's eye position in the images, and tracking its motion to determine the user's gaze direction.

Gaze is an important indicator of visual attention, and knowledge of a user's gaze may be used in a myriad of applications. For example, in healthcare, gaze estimation may be used for detecting both physical and psychological issues of users. Analyzing the gaze of a user involved in the test may provide useful information about issues such as autism spectrum disorders, degenerative diseases, and/or vision problems, to name a few.

The integration of gaze estimation technology into virtual reality (VR) and mixed reality (MR) (collectively referred to herein as extended reality (XR)) headsets (e.g., head mounted displays (HMDs) with built-in gaze trackers) is also becoming increasingly common. For example, gaze may be used as an explicit input control mechanism, such as for users to achieve gaze-controlled functions (e.g., selecting, navigating menus, etc. when using the XR headsets). Gaze may also be used to infer a user's intended future actions and/or cognitive states. This information may help to enhance XR user experience, for example, by enabling personalization, content recommendations, adaptive guidance, and/or the like. For example, the headset may automatically bring up weather information when the user is determined to be looking outside their window.

Further, gaze estimation technology may be implemented in handheld devices, such as smartphones or tablets. For example, a front camera of a handheld device may be used to track the gaze of a user using the device to activate functions such as locking/unlocking the device, interactive displays, dimming backlights, etc.

In the automotive context, real-time eye tracking and gaze estimation may also play an important role in evaluating driver vigilance. For example, driven by regulation and legislation, car manufacturers are now deploying driver monitoring systems (DMSes) that can detect driver impairment and enable appropriate interventions. A DMS (also referred to as “a driver state sensing (DSS) system”) is an advanced safety feature of a vehicle that may be designed to include eye tracking and gaze estimation technology, which may be used to at least (1) determine driver drowsiness and/or distraction (among other factors) using an image sensor deployed within the vehicle and (2) issue warning(s) and/or alert(s) to help re-focus a driver's attention towards the task of driving the vehicle, when necessary. In certain aspects, the image sensor is a driver-facing camera that captures information about the driver's head position, head pose, eye location, and eye movements, to name a few (e.g., low-level features). In some examples, this information may be used by the DMS to analyze the driver's attentiveness while driving. For example, this information may be used to determine whether a driver is looking at the road ahead and/or whether the driver is paying attention or just absent-mindedly staring, to thereby determine a distraction level of the driver. The DMS may warn a driver when dangerous driving is detected (e.g., when a dangerously distracted level of a driver is detected) to help avoid vehicular crashes, and in some cases, save lives.

It should be noted that the above-described applications of user gaze are not an exhaustive list, and many other applications may benefit from the implementation of gaze estimation techniques, such as in education and e-learning, in consumer psychology, and marketing, and/or the like.

### SUMMARY

One aspect provides a method by an apparatus. The method includes estimating a first gaze direction of a user based on at least one or more first two-dimensional (2D) images of a face of the user, wherein the first gaze direction is represented as a first yaw angle and a first pitch angle in a camera coordinate system; and associating the first gaze direction of the user with a first gaze zone among a plurality of gaze zones based on: the first yaw angle; the first pitch angle; and a first Gaussian distribution of the first gaze zone, wherein the first Gaussian distribution is based on a plurality of gaze directions, of a plurality of users, associated with the first gaze zone.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts example partitioning of a gaze region of a user into multiple gaze zones.

FIG. 2 depicts an example workflow for gaze zone detection.

FIG. 3A depicts an example camera coordinate system and an example head coordinate system.

FIG. 3B depicts example relationships between an example camera coordinate system and an example head coordinate system.

FIG. 4 depicts example Gaussian distribution determination for different gaze zones.

FIGS. 5A-5D depict example gaze direction adjustment based on head location.

FIG. 6 depicts example yaw angle adjustment.

FIG. 7 depicts a method for gaze zone detection.

FIG. 8 depicts an example device configured to perform gaze zone detection.

### DETAILED DESCRIPTION

Aspects of the present disclosure provide apparatuses, methods, processing systems, and computer-readable mediums for improved gaze zone detection for a user. For example, aspects herein provide a Gaussian-based method for gaze zone detection, described in detail below. Gaze zone detection may refer to a technique for associating a user's estimated gaze direction (e.g., estimated based on head pose and eye location for the user) with a particular gaze zone among various discrete gaze zones. A gaze zone determined to be associated with a user's estimated gaze direction may be an indicator of the user's point of interest in terms of direction, location, attention, and/or interactions.

In certain aspects, the Gaussian-based method for gaze zone detection, described herein, may be used to determine a user's (e.g., driver's) attentiveness while operating a vehicle. Thus, aspects herein may be described with respect to the use of gaze estimation and gaze zone detection techniques in the automotive context. However, it is noted that the techniques described herein may similarly be applied in other applications, such as for improved gaze zone detection in XR applications, for handheld devices, and/or for medical diagnosis (e.g., as described above), among others.

When operating a vehicle, for example, a gaze region of a driver (e.g., a gaze region in front, left, and/or right of a driver) may be partitioned into several gaze zones. The gaze zones may include coarse gaze areas that drivers generally look at while driving. A gaze direction estimation for a driver may be associated with one of the gaze zones. For example, an “associated gaze zone” may represent an area that the driver is predicted to be looking at. Thus, the associated gaze zone may help in determining if the driver is distracted or attentive while driving (e.g., for DMSes, coarse gaze direction prediction, instead of exact gaze location prediction, may be acceptable to determine driver attentiveness).

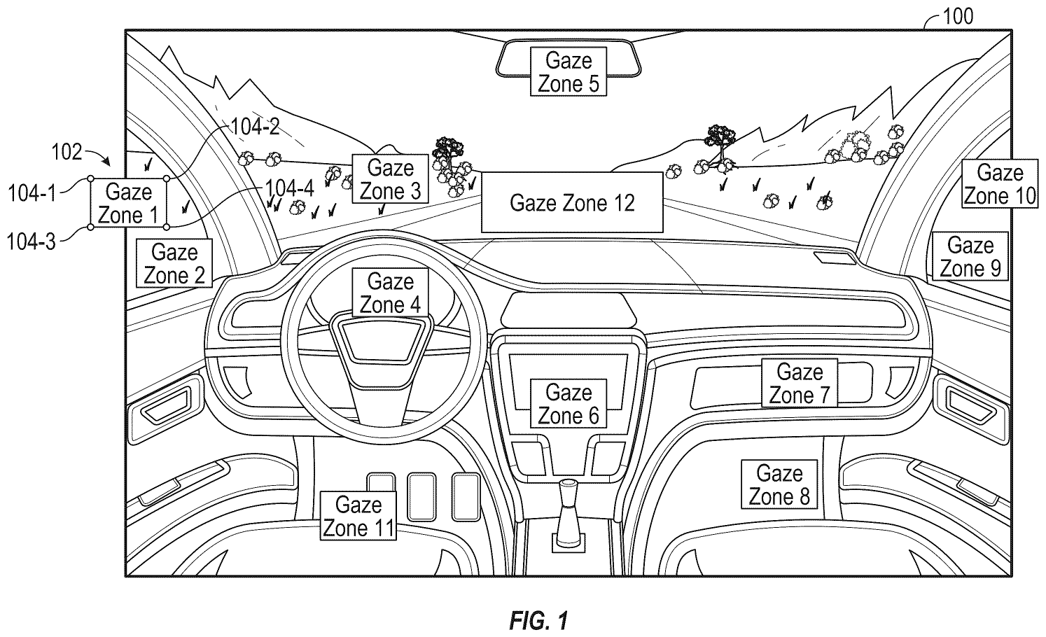

For example, as shown in FIG. 1, a gaze region 100 may be partitioned into twelve gaze zones 102. Gaze zone 1 may correspond to a driver side window, gaze zone 2 may correspond to a driver size mirror, gaze zone 3 may correspond to scenery in front of a driver, gaze zone 4 may correspond to a dashboard, gaze zone 5 may correspond to a rearview mirror, gaze zone 6 may correspond to an infotainment system, gaze zone 7 may correspond to a glove box, gaze zone 8 may correspond to a passenger's footwell, zone 9 may correspond to a passenger size mirror, zone 10 may correspond to a passenger side window, gaze 11 may correspond to a driver's footwell, and gaze zone 12 may correspond to the road. In certain aspects, each gaze zone in a 3D world coordinates system may be defined as a polygon, such as with four corner points: a top left corner point 104-1, a top right corner point 104-2, a bottom left corner point 104-3, and a bottom right corner point 104-4. A gaze direction of a driver determined to be associated with gaze zone 12 (e.g., the road), for example, may indicate that the driver is not distracted. However, a gaze direction of a driver determined to be associated with gaze zone 6 (e.g., the infotainment system), for example, may indicate that the driver is distracted. If gaze zone 6 is determined to be the gaze zone associated with the gaze direction of the driver, then further action may be taken to re-focus the driver's attention on the current driving task.

It is noted that FIG. 1 provides only a few examples of gaze zones, and in other examples, different partitioning of a gaze region may result in different gaze zones with different gaze zone sizes and/or shapes.

Estimating a gaze direction of a driver for gaze zone detection is a technically challenging task. Subtle movements of the eye can change the gaze direction dramatically, and the difficulty of the task may vary greatly across drivers. Further, techniques for determining head pose and eye location of a driver, for gaze direction estimation, may suffer from one or more technical problems.

For example, in certain DMSes, head pose for a driver may be estimated from two-dimensional (2D) images taken using a monocular image sensor (e.g., camera). Specifically, a single monocular image sensor may be installed close to a steering wheel in a vehicle for tracking a driver's feature points. Feature points may be facial landmarks (e.g. eyes, nose, mouth, etc.) and/or arbitrary points on the driver's face. Head pose determination may be based on geometric head models and the tracking of such feature points on the head model across images. Thus, head pose determination may rely either on a precise detection of facial landmarks or a frame-to-frame face detection. A technical problem with using this method for head pose estimation is that the method may fail at large rotation angles of the head, for example, when facial landmarks become occluded to the image sensor. Methods based on tracking arbitrary features on the face surface may cope with larger rotations, but tracking of these features may be unstable, for example, due to low texture and/or changing illumination. In addition, the face detection at large rotation angles may be less reliable than in a frontal view.

Similar technical problems may also be encountered when determining eye location for a driver using a single monocular image sensor. For example, when a single monocular image sensor is used to detect the eye location, excessive rotation of the driver's head may prevent the eye region from being accurately detected, thereby reducing the eye location accuracy.

Further, many gaze estimation methods may not take into account eye-variation parameters, such as kappa angle (e.g., an angle between the visual axis and an optical axis of the eye), across drivers, although such parameters may be important for accurate gaze estimation. For example, as described above, 3D gaze estimation refers to the estimation of the visual axis of the eye. The visual axis of an eye passes through the fovea and the corneal center of the eye. The visual axis may be determined only by the corneal center due to the invisibility of the fovea. Thus, some gaze estimation methods may reconstruct an optical axis (also commonly referred to as a “pupillary axis”) of the eye first, and then use the kappa angle to generate the visual axis from the optical axis. The optical axis refers to an axis of the eye that passes through the eye center, the corneal center, the iris center, and the pupil center, and is perpendicular to the iris or pupil plane. The kappa angle may be different across drivers, and thus, it may not be practical to use a fixed kappa angle value for generating the visual axis. However, some gaze estimation methods may fail to take into account the variations in kappa angle across drivers thereby leading to inaccurate gaze direction estimation, and thus gaze zone detection.

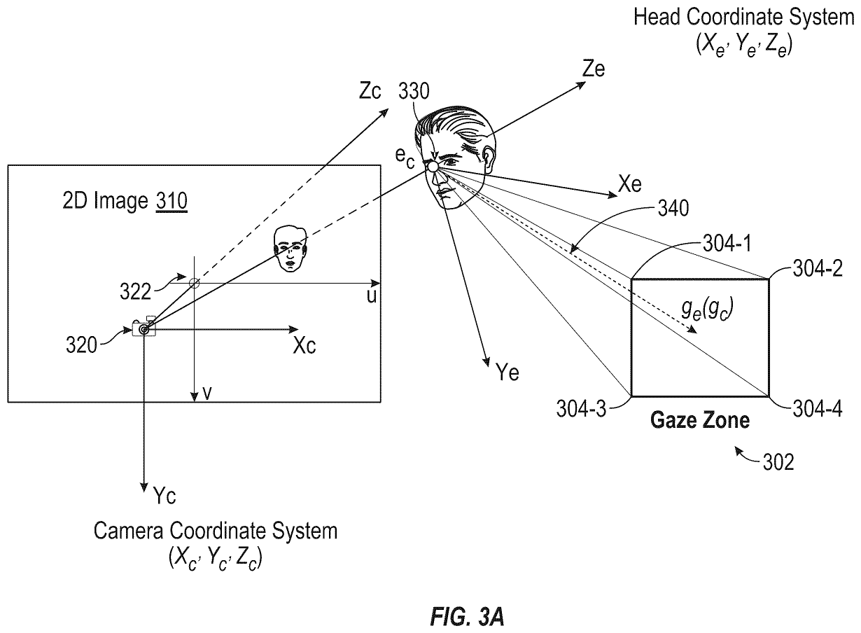

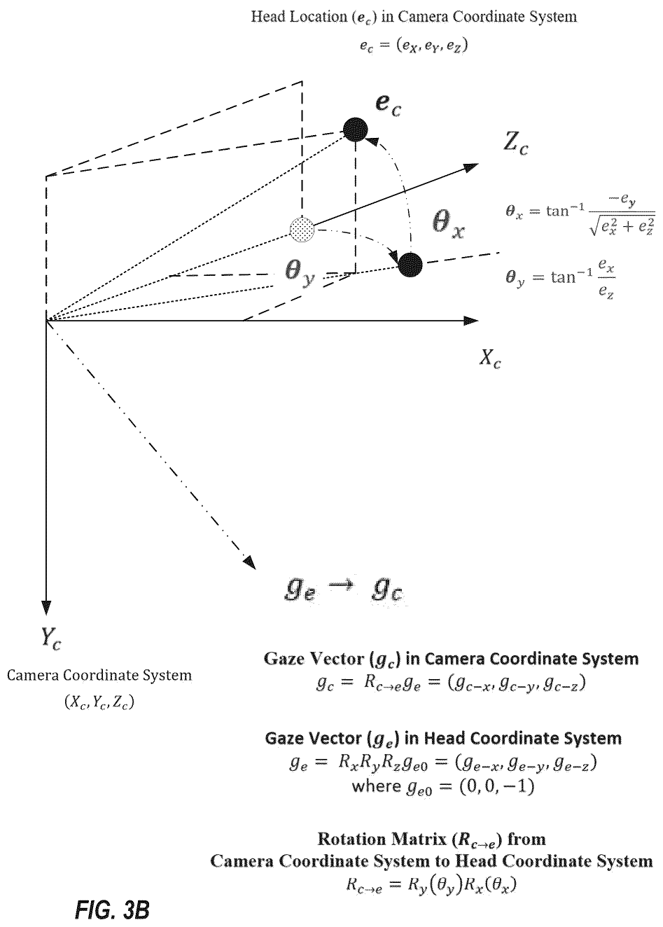

To help overcome the aforementioned technical problems and improve upon the state of the art, certain aspects described herein provide a Gaussian-based method for gaze zone detection. For the Gaussian-based method, a driver's gaze direction may be estimated and used to determine a Gaussian response for each gaze zone, where a Gaussian response is an output of a Gaussian function. The Gaussian response determined for each gaze zone may be based on (1) the driver's gaze direction represented as a yaw angle and a pitch angle in a camera coordinate system (e.g., a 3D coordinate system, such as for a perspective pinhole camera model, with its origin represented as the location of a camera lens center), which is depicted and described below with respect to FIGS. 3A-3C), (2) a pitch angle mean and a yaw angle mean determined for the respective gaze zone, and (3) a pitch angle variance and a yaw angle variance determined for the respective gaze zone. For example, the Gaussian response (f(α, β)) determined for each gaze zone may be computed according to the equation:

$$f ( α , β ) = A exp ( - ( \frac{{( α - {α}_{0} )}^{2}}{2 {σ}_{α}^{2}} ) + ( \frac{{( β - {β}_{0} )}^{2}}{2 {σ}_{β}^{2}} ) )$$

where α represents the yaw angle estimated for the driver (e.g., as part of the gaze estimation), β represents the pitch angle estimated for the driver (e.g., as part of the gaze estimation), (α₀, β₀) represents the yaw angle mean and the pitch angle mean, respectively, associated with the respective gaze zone, and (σ_{α}², σ_{β}²) represents the yaw angle variance and the pitch angle variance, respectively, associated with the respective gaze zone. As shown in the above equation, the driver's gaze direction, represented as a yaw angle (α) and a pitch angle (β), may be compared to a mean gaze direction, represented as a yaw angle mean (α₀) and pitch angle mean (β₀), for each respective gaze zone to determine the Gaussian response (f(α,β)) for each respective gaze zone. The closer the driver's gaze direction is to the mean gaze direction associated with a particular gaze zone, the higher the calculated Gaussian response may be for the particular gaze zone (e.g., indicating higher density and further, a higher likelihood that the driver is looking at the particular gaze zone).

The yaw angle mean (α₀), the pitch angle mean (β₀), the yaw angle variance (σ_{α}²), and the pitch angle variance

$$( {σ}_{β}^{2} )$$

associated with each respective gaze zone may be calculated based on gaze directions, collected for multiple users, associated with each respective gaze zone. More specifically, gaze directions of different users with different heights and/or sitting positions within the same vehicle (or similar type of vehicle) and known to be associated with a first gaze zone may be used to calculate such values for the first gaze zone. For example, the yaw angle mean (α₀) may be calculated based on the yaw angles of the different users, the pitch angle mean (β₀) may be calculated based on the pitch angles of the different users, etc.

The gaze zone for the driver may be estimated by first reconstructing a 3D face model from one or more 2D images of the user's face (e.g., collected via the image sensor installed within the vehicle). In certain aspects, the 3D face model may be a 3D morphable model (3DMM) model. A head pose, one or more facial landmarks of the user corresponding to eye location(s) of the driver, and a head position of the driver in the camera coordinate system may be estimated using the re-constructed 3D face model. Second, eye image patches for the driver may obtained. In certain aspects, the facial landmarks of the driver (e.g., eye corner landmarks of the user) may be used to normalize the obtained eye image patches to a fixed-sized eye image patch pair. In certain aspects, the driver's eye locations may be derived from the head position estimated using the 3DMM model. Third, a gaze estimation network may process the head pose and the eye image patches (e.g., two normalized eye image patches, where the roll angle is corrected to zero) of the driver to estimate an absolute gaze direction of the driver in a head coordinate system (e.g., a 3D coordinate system with its origin represented as the location of the driver's head, which is depicted and described below with respect to FIGS. 3A-3B). For example, the eye image patches associated with the driver may be used to determine a relative eye gaze of the driver, where the relative eye gaze corresponds to a frontal head pose of the driver. The relative eye gaze may then be used in combination with the head pose to determine the absolute gaze direction (simply referred to herein as the “gaze direction”) of the driver in a head coordinate system.

Fourth, the head position of the driver may then be used to convert the gaze direction of the driver in the head coordinate system to a gaze direction of the driver in the camera coordinate system. This gaze direction of the driver in the camera coordinate system may be represented as a yaw angle (α) and a pitch angle (β), which are variables used in determining the per-gaze zone Gaussian response (e.g., per the equation above).

Fifth, the gaze direction (yaw angle, pitch angle or (α, β)) of the driver may be associated with a gaze zone having a greatest Gaussian response among the multiple gaze zones. For example, if the Gaussian response determined for a first gaze zone (e.g., such as gaze zone 1 in FIG. 1 corresponding to a driver side window) is the greatest among the Gaussian responses determined for other gaze zones (e.g., such as gaze zones 2-12 in FIG. 1), then the system may determine that the driver is looking at the first gaze zone. The system may determine if the driver is distracted or not based on the type of the first gaze zone (e.g., driver side window, road, dashboard, etc.) and take action accordingly (e.g., take no action, alert the driver, etc.).

In certain aspects, the gaze direction of each user associated with each gaze zone (used to determine the gaze zone means and variances, as described above), as well as the gaze direction estimated for the driver, may be adjusted to compensate for differences in head location of the driver and/or one or more of the users. For example, the yaw angles and pitch angles of users associated with a gaze zone may correspond to different head locations from a same image sensor installed in a vehicle (e.g., some may be closer or farther away from the image sensor than others). To compensate for the differences in head location from the image sensor, the yaw angles and pitch angles may be adjusted such that the yaw angles and pitch angles correspond to a same distance from the image sensor (e.g., adjusted to an average head location). These adjusted yaw angles and adjusted pitch angles may be used to calculate an adjusted yaw angle mean (α_{0,adj}), an adjusted pitch angle mean (β_{0,adj}), an adjusted yaw angle variance

$$( {σ}_{a , adj}^{2} ) ,$$

and an adjusted pitch angle variance

$$( {σ}_{β , adj}^{2} )$$

for the gaze zone. Similarly, the gaze zone estimated for a driver may be adjusted such that the gaze direction for the driver (α_{adj},β_{adj}) represents a pitch angle and yaw angle for the driver corresponding to the average head location. The adjusted yaw angle mean (α_{0,adj}), the adjusted pitch angle mean (β_{0,adj}), the adjusted yaw angle variance

$$( {σ}_{a , adj}^{2} ) ,$$

and the adjusted pitch angle variance

$$( {σ}_{β , adj}^{2} )$$

associated with the respective gaze zone, as well as the driver's adjusted gaze direction (α_{adj},β_{adj}), may be used to determine an adjusted Gaussian response for the respective gaze zone according to the equation:

$$f ( {α}_{adj} , {β}_{adj} ) = A exp ( - ( \frac{{( {α}_{adj} - {α}_{0 , adj} )}^{2}}{2 {σ}_{α , adj}^{2}} ) + ( \frac{{( {β}_{adj} - {β}_{0 , adj} )}^{2}}{2 {σ}_{β , adj}^{2}} ) )$$

Similar methods may be used to determine the adjusted means, adjusted variances, and adjusted Gaussian responses for each gaze zone to associate one of the gaze zones with the adjusted gaze direction of the driver.

Certain techniques for gaze zone detection described herein may provide various beneficial technical effects and/or advantages. For example, the techniques for gaze zone detection may enable more accurate gaze direction estimation and gaze zone detection. The improved gaze zone detection may be attributable to the use of a Gaussian distribution for each gaze zone when determining which gaze zone is associated with the gaze direction of the driver. For example, the Gaussian distribution may be based on gaze directions of users with various kappa angles to help compensate for errors due to the use of a fixed kappa angle for gaze estimation. In certain aspects, the improved gaze zone detection may be further attributable to the use of adjusted yaw and pitch angles for determining the associated gaze zone. In particular, adjusting the yaw and pitch angles to correspond to a same head location from an image sensor installed in a vehicle for gaze zone detection may help to achieve more accurate gaze zone detection.

Further, the use of the 3DMM model may help to determine the head pose and location of the driver's eyes, which may be difficult to estimate using a monocular camera. For example, the 3DMM model may provide a 3D head mesh for a user based on a 2D face image (e.g., a cropped face image) of the user provided as input into the model. The head position of the user may be estimated using the 3DMM model given it is a 3D model. Further, in certain aspects, the 3D head mesh may be transformed back to the input 2D image, such as with perspective transform, to check whether facial landmarks of the user match the facial landmarks detected using the 3DMM model. Further, the 3DMM model, using a cropped face image of a user to construct the 3D head mesh, does not require the 3DMM model to have information about the exact face location of the user in the image, which may be a challenging to identify. The 3DMM model uses a weak perspective transform to re-project the user's face with the assumption that the user's head is at a certain depth with a scale factor to adjust head the head size.

As described above, although the techniques described herein for gaze zone detection are described with respect to associating a gaze direction of a driver with a gaze zone inside and/or outside of a vehicle, the techniques described herein may be similarly applicable in other scenarios. For example, the techniques described herein may be used to estimate a gaze direction for any user and associate the gaze direction of the user with any pre-defined gaze zone. Specifically, the techniques described herein may be applied in many other applications, such as for human-computer interaction, in the health care and/or medical field, in education and e-learning, in consumer psychology and marketing, and/or the like.

### Example Workflow for Gaze Zone Detection

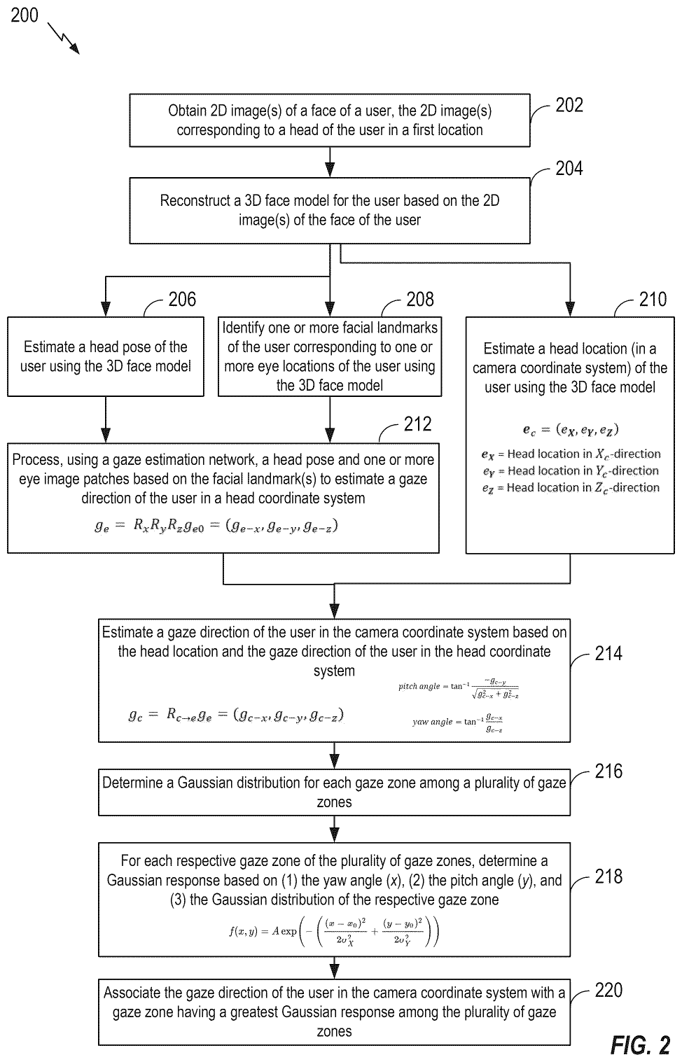

FIG. 2 depicts an example workflow 200 for gaze zone detection. For example, workflow 200 may be used to estimate a gaze direction of a user and associate the gaze direction of the user with one gaze zone among a plurality of gaze zones. In certain aspects, the user may be a driver in a vehicle, and the gaze zones may correspond to areas that a driver of the vehicle may be looking at while driving the vehicle. For example, the gaze zones may include one or more of the gaze zones 102 depicted and described above with the respect to FIG. 1 and/or one or more other gaze zones.

As shown in FIG. 2, workflow 200 begins at 202 with obtaining 2D image(s) of a face of the user. The 2D image(s) may correspond to a head of the user in a first location. In certain aspects, the first location may be a distance a from an image sensor used to obtain the 2D image(s). In certain aspects, the image sensor is a monocular camera.

As an illustrative example, a user may be sitting in a driver's seat of a vehicle. The vehicle may include a monocular camera installed close to a steering wheel in the vehicle for obtaining 2D image(s) of the face of the driver over time. The driver may be sitting with its head a distance p away from the monocular camera (e.g., the first location).

FIG. 3A depicts an example 2D image 310 captured at 202 (e.g., via a camera). The example 2D image 310 may capture a face and head of the user in a camera coordinate system. Put differently, the captured head and face in 2D image 310 may be defined relative to a center of the camera lens (e.g., pinhole) used to capture 2D image 310. The camera coordinate system may be a 3D coordinate system with origin 320 and axis lines (X_{c}, Y_{c}, Z_{c}), oriented as shown in FIG. 3A. Origin 320 may represent the location of the camera. A distance along the X_{c} axis from origin 320 may represent left or right movement away from the center of the camera. A distance along the Y_{c} axis from origin 320 may represent up or down movement away from the center of the camera. Further, a distance along the Z_{c} axis from origin 320 may represent a negative distance away from origin 320 (e.g., such as towards the back of a vehicle when the camera is installed at the front of the vehicle).

A location of the captured head in the 2D image 310, or more specifically, with respect to the 2D image coordinate system, may be represented as (u₁, v₁). The 2D image coordinate system associated with the 2D image 310 may be a 2D coordinate system with an origin 322 (e.g., center of the 2D image 310), a u-axis, and a v-axis, such as shown in FIG. 3A. The center of 2D image 310, or origin 322 in the 2D image coordinate system, may be represented as point (0, 0, f) in the camera coordinate system, where f represents the focal length of the camera used to capture 2D image 310.

A location of the captured head (e.g., head location (e_{c})) in the camera coordinate system may be represented as:

$${e}_{c} = ( {e}_{X} , {e}_{Y} , {e}_{Z} )$$

where e_{X} represents the head location in the X_{c} direction (e.g., along the X_{c} axis), e_{Y} represents the head location in the Y_{c} direction (e.g., along the Y_{c} axis), and e_{Z} represents the head location in the Z_{c} direction (e.g., along the Z_{c} axis). Head location (e_{c}) in the camera coordinate system is represented by 330 in FIG. 3A.

In certain aspects, camera intrinsics (e.g., focal length (f)) of the camera used to capture 2D image 310, location of the captured head in the 2D image 310, (u₁, v₁), and a depth network may be used to determine head location (e_{c}) in the camera coordinate system. For example, the head location head location (e_{c}) may be calculated as:

$${e}_{c} = z / f * ( {u}_{1} , {v}_{1} , f )$$

where u₁ and v₁ represent the location of the captured head in 2D image 310 (e.g., in the 2D image coordinate system) and f represent the focal length of the camera (e.g., a pixel may be represented as (u, v, f)). A depth network may be used to determine z in order to get the exact 3D head location (e_{c}) in the camera coordinate system. A depth network is a machine learning (ML) model that may take as input a 2D image and estimate depth for object(s) in the image. In certain aspects, the depth network may be dependent on the output of a 3DMM network, such as a 3DMM network used to reconstruct a 3D face model for the user based on 2D image 310 (e.g., described in detail below). From the output of a feature layer of the 3DMM network, before a final 3DMM regressor layer, the 3DMM network may be used to estimate the head location of the user based on a weak perspective transform. In certain aspects, a default head location is set to 50 centimeters (cm) away from the camera used to capture 2D image 310, and a scale factor may be used to adjust the final distance.

Workflow 200 proceeds, at 204, with reconstructing a 3D face model for the user based on the 2D image(s) of the face of the user. In certain aspects, the 3D face model is a 3DMM model. For example, the 3DMM model is a model that may be used to compute a 3D head mesh (e.g., with thousands of vertices) with principal component analysis (PCA) to thereby model a head mesh through a set of PCA coefficients. These PCA coefficients may represent head shape (identity) and expressions separately. With the combination of the PCA coefficients and a predefined mean face and eigenvectors, any head shape may be reconstructed. In certain aspects described herein, the 3DMM model may take a normalized 2D face image as input, such as normalized 2D image 310, and output a shape coefficient, an expression coefficient, head pose (e.g., pitch, yaw, roll) and/or head translation (e.g., x, y, z translation).

Workflow 200 then proceeds, at 206 and 208, with (1) estimating a head pose of the user using the 3D face model and (2) identifying one or more facial landmarks of the user using the 3D face model. For example, as described above, the 3DMM model may be used to output the head pose (e.g., in some cases in addition to the head shape, expression, and/or translation) as model output. The facial landmarks may include 2D facial landmarks of the user. In certain aspects, the facial landmarks may correspond to one or more eye locations of the user. For example, the facial landmarks may be used to crop eye image patches for the user, as well as normalize the in-plane direction and size of the eye image patches. In certain aspects, the eye image patches may be normalized to a fixed-size eye image patch pair based on eye corner landmarks of the user.

In certain aspects, the head pose estimated at 206 is modified to normalize the roll of the head to zero. For example, in-plane rotation angles of the head from a roll angle of the head are obtained to determine a modified head pose of the user, where roll of the head is normalized to zero.

Workflow 200 then proceeds, at 212, with processing the head pose (e.g., estimated at 206) and the eye image patches (e.g., created based on the facial landmark(s) identified at 208). The head pose and eye image patches may be processed to estimate a gaze direction (gₑ) of the user in a head coordinate system. Put differently, the estimated gaze direction (gₑ) of the user may be defined relative to a center of the head of the user. The head coordinate system may be a 3D coordinate system with origin 330 and axis lines(Xₑ, Yₑ, Zₑ), oriented as shown in FIG. 3A.

In certain aspects, a gaze estimation network is used to process the head pose and eye image patches at 212 to estimate the gaze direction (gₑ) of the user in the head coordinate system.

The estimated gaze direction (gₑ) of the user in the head coordinate system may be represented as:

$${g}_{e} = ( {g}_{e - x} , {g}_{e - y} , {g}_{e - z} )$$

where each element of gₑ, such as gₑ₋ₓ, g_{e-y}, and g_{e-z}, represent the x, y, and z locations, respectively, of the directional vector in Cartesian coordinates (e.g., instead of angles). The estimated gaze direction (gₑ) of the user in the head coordinate system has an implicit constraint of length=1. The estimated gaze direction (gₑ) of the user in the head coordinate system may be considered as a 3D point on a surface of a unit sphere (e.g., radius=1), which centers on (0, 0, 0) of the head coordinate system.

The estimated gaze direction (gₑ) of the user in the head coordinate system may also be represented as:

$${g}_{e} = {R}_{x} {R}_{y} {R}_{z} {g}_{e 0}$$

where gₑ₀=(0, 0, −1) represents the default gaze direction in the head coordinate system along the negative Zₑ-axis (e.g., the user captured in the image may be looking at the camera, no matter where the user is located). Further, (RₓR_{y}R_{z}) may represent the absolute gaze rotation matrices corresponding to pitch, yaw, and roll rotations, respectively.

Returning to 204, in certain aspects workflow 200 also proceeds, at 210, with estimating a head location (e_{c}) of the user. The head location (e_{c}) of the user may be estimated in the camera coordinate system. As described above, the head location (e_{c}) of the user in the camera coordinate system may be represented as:

$${e}_{c} = ( {e}_{X} , {e}_{Y} , {e}_{Z} )$$

where the head location head location (e_{c}) may be calculated as:

$${e}_{c} = z / f * ( {u}_{1} , {v}_{1} , f )$$

as described above.

Workflow 200 then proceeds, at 214, with estimating a gaze direction (g_{c}) of the user in the camera coordinate system. In certain aspects, the gaze direction (g_{c}) of the user in the camera coordinate system is determined based on (1) the head location (e_{c}) of the user in the camera coordinate system, estimated at 210, and (2) the gaze direction (gₑ) of the user in a head coordinate system, estimated at 212.

For example, the gaze direction (g_{c}) of the user in the camera coordinate system may be determined according to the equation:

$${g}_{c} = {R}_{c \to e} {g}_{e}$$

$$where$$

$${R}_{c \to e} = {R}_{y} ( {θ}_{y} ) {R}_{x} ( {θ}_{x} )$$

and where R_{c→e} represents the rotation matrix from the camera coordinate system to the head coordinate system, Rₓ(θₓ) represents the absolute gaze rotation matrix corresponding to pitch, and R_{y}(θ_{y}) represents the absolute gaze rotation matrix corresponding to yaw. In certain aspects, θₓ and θ_{y} are determined using the gaze estimation network (e.g., used at 212 to process the head pose and the eye image patches). Further,

$${θ}_{x} = {tan}^{- 1} \frac{- {e}_{Y}}{\sqrt{{e}_{X}^{2} + {e}_{Z}^{2}}}$$

$$and$$

$${θ}_{y} = {tan}^{- 1} \frac{{e}_{X}}{{e}_{Z}}$$

where e_{X} represents the head location in the X_{c} direction (e.g., along the X_{c} axis), e_{Y} represents the head location in the Y_{c} direction (e.g., along the Y_{c} axis), and e_{Z} represents the head location in the Z_{c} direction (e.g., along the Z_{c} axis).

FIG. 3A depicts the example camera coordinate system and the example head coordinate system. As described above, the camera coordinate system may be a 3D coordinate system with origin 320 and axis lines (X_{c}, Y_{c}, Z_{c}), oriented as shown in FIG. 3A. Further, as described above, the head coordinate system may also be a 3D coordinate system with origin 330 and axis lines (Xₑ, Yₑ, Zₑ), oriented as shown in FIG. 3A.

A gaze direction (gₑ) of the user in a head coordinate system may be represented by line 340. The gaze direction (gₑ) may be associated with a gaze zone 302 defined by corner points 304-1, 304-2, 304-3, and 304-4. In certain aspects, gaze zone 302 may be an example of one of the gaze zones 102 depicted and described above with respect to FIG. 1.

FIG. 3B depicts example relationships between the camera coordinate system and head coordinate system to convert the gaze direction (gₑ) of the user in the head coordinate system to a gaze direction (g_{c}) of the user in the camera coordinate system. Specifically, as described above g_{c}=R_{c→e}gₑ; thus, the gaze direction (gₑ) is related to the gaze direction (g_{c}) by rotation matrix R_{c→e}. Rotation matrix R_{c→e} is based on θₓ and θ_{y}, as depicted in FIG. 3B.

Gaze direction (g_{c}) of the user in the camera coordinate system, determined at 214, may be represented as:

$${g}_{c} = ( {g}_{c - x} , {g}_{c - y} , {g}_{c - z} )$$

where each element of g_{c}, such as g_{c-x}, g_{c-y}, and g_{c-z}, represent the x, y, and z locations, respectively, of the directional vector in Cartesian coordinates (e.g., instead of angles) originating from a zero point. The estimated gaze direction (g_{c}) of the user in the camera coordinate system is a unit vector and has an implicit constraint of length=1. The estimated gaze direction (g_{c}) of the user in the camera coordinate system may be considered as a 3D point on a surface of a unit sphere (e.g., radius=1), which centers on (0, 0, 0) of the camera coordinate system.

The gaze direction (g_{c}) of the user in the camera coordinate system may also be represented as a pitch angle (β) and a yaw angle (α) (e.g., spherical coordinates), where the pitch angle (β) is represented by the equation:

$$β = pitch angle = {tan}^{- 1} \frac{- {g}_{c - y}}{\sqrt{{g}_{c - x}^{2} + {g}_{c - z}^{2}}}$$

and the yaw angle (α) is represented by the equation:

$$α = yaw angle = {tan}^{- 1} \frac{{g}_{c - x}}{{g}_{c - z}}$$

The pitch angle (β) and the yaw angle (α) may represent angles for the gaze of the user in the camera coordinate system.

Returning to FIG. 2, workflow 200 proceeds, at 216, with determining a Gaussian distribution for each gaze zone among of a plurality of gaze zones. For example, for N gaze zones (e.g., such as 12 gaze zones depicted in FIG. 1), N Gaussian distributions (e.g., 12 Gaussian distributions) may be determined (e.g., where N is an integer greater than zero).

Multiple gaze directions may be associated with each gaze zone. The multiple gaze directions associated with each gaze zone may include gaze directions of users with various user heights, sitting positions and/or head locations. Each gaze direction may be represented by a pitch angle and a yaw angle. In certain aspects, data associated with the users, associated with each gaze zone, may be collected (e.g., including annotations and/or information about their gaze directions) and used to calculate the Gaussian distribution for each respective gaze zone.

To determine a Gaussian distribution for a first gaze zone of the multiple gaze zones, a pitch angle mean (β₀) may be calculated from the multiple pitch angles (e.g., of the multiple gaze directions) associated with the first gaze zone. Further, a yaw angle mean (α₀) may be calculated from the multiple yaw angles associated with the first gaze zone. A pitch angle variance

$$( {σ}_{β}^{2} )$$

may be calculated from the multiple pitch angles associated with the first gaze zone, and a yaw angle variance

$$( {σ}_{α}^{2} )$$

may be calculated from the multiple yaw angles associated with the first gaze zone. The Gaussian distribution for the first gaze zone may be determined based on at least the pitch angle mean (β₀), the yaw angle mean (α₀), the pitch angle variance

$$( {σ}_{β}^{2} ) ,$$

and the yaw angle variance

$$( {σ}_{α}^{2} ) .$$

This process may be repeated for each gaze zone to determine the Gaussian distribution per gaze zone.

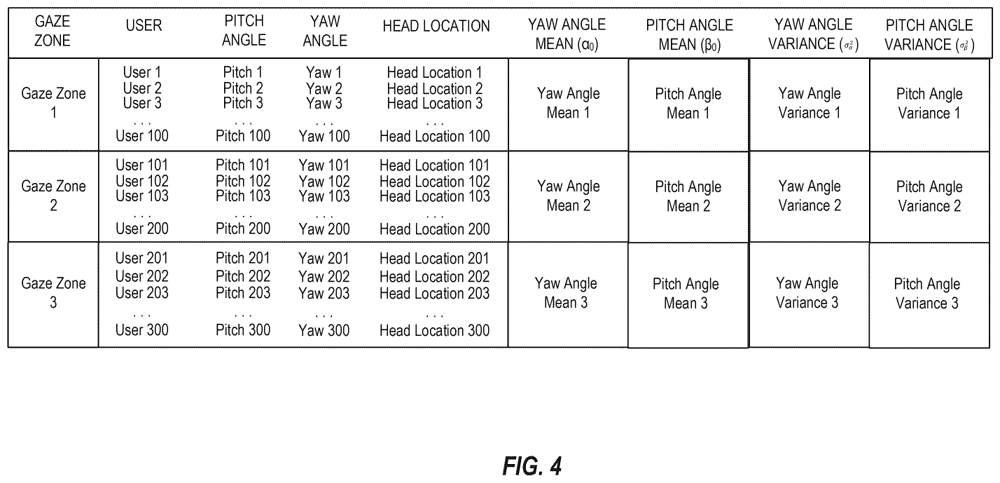

FIG. 4 depicts example Gaussian distribution determination for three gaze zones (e.g., gaze zone 1, gaze zone 2, and gaze zone 3). 100 gaze directions for 100 users, represented as Pitch 1-100 and Yaw 1-100, may be used to determine a Gaussian distribution for gaze zone 1. 100 gaze directions for another 100 users, represented as Pitch 101-200 and Yaw 101-200, may be used to determine a Gaussian distribution for gaze zone 2. Further, 100 gaze directions for another 100 users, represented as Pitch 201-300 and Yaw 201-300, may be used to determine a Gaussian distribution for gaze zone 3.

For example, for gaze zone 1, pitch angle mean 1 may be calculated as the average of pitches 1-100, and yaw angle mean 1 may be calculated as the average of yaws 1-100. Pitch angle variance 1 may be calculated as the variance of pitches 1-100, and yaw angle variance 1 may be calculated as the variance of yaws 1-100. A Gaussian distribution for gaze zone 1 may be determined based at least in part on pitch angle mean 1, yaw angle mean 1, pitch angle variance 1, and yaw angle variance 1.

Gaussian distributions for gaze zone 2 and gaze zone 3 may be similarly determined.

Returning to FIG. 2, workflow 200 then proceeds, at 218, with determining a Gaussian response for each respective gaze zone of the plurality of gaze zones. For example, for N gaze zones (e.g., such as 12 gaze zones depicted in FIG. 1), N Gaussian responses (e.g., 12 Gaussian responses) may be determined. The Gaussian response determined for each gaze zone may be determined based on (1) the gaze direction pitch angle (β) for the user in the camera coordinate system (e.g., determined at 214), (2) the gaze direction yaw angle (α) for the user in the camera coordinate system (e.g., determined at 214), and (3) the Gaussian distribution of the respective gaze zone (e.g., determined at 216).

For example, the Gaussian response (f(α,β)) determined for each gaze zone may be determined according to the equation:

$$f ( α , β ) = A exp ( - ( \frac{{( α - {α}_{0} )}^{2}}{2 {σ}_{α}^{2}} ) + ( \frac{{( β - {β}_{0} )}^{2}}{2 {σ}_{β}^{2}} ) )$$

where β represents the pitch angle estimated for the user (e.g., as part of the gaze direction estimation), a represents the yaw angle estimated for the user (e.g., driver) (e.g., as part of the gaze direction estimation), (α₀, β₀) represents the yaw angle mean and the pitch angle mean, respectively, associated with the respective gaze zone, (σ_{α}², σ_{β}²) represents the yaw angle variance and the pitch angle variance, respectively, associated with the respective gaze zone.

After determining the Gaussian response (f(α,β)) for each gaze zone, workflow 200 proceeds, at 220, with associating the gaze direction of the user in the camera coordinate system with a gaze zone having a greatest Gaussian response among the plurality of gaze zones.

In certain aspects, a greatest Gaussian response may be associated with multiple gaze zones (e.g., indicating that the gaze direction of the user may be associated with multiple gaze zones). In such cases, the gaze zone determined to be associated with the gaze direction of the user may be selected as the gaze zone with the shortest distance between the head location of the user and the respective gaze zone.

Accordingly, workflow 200 may be used to determine if the gaze direction of the user, represented as a pitch angle and a yaw angle in the camera coordinate system, is associated with a gaze zone (e.g., a fixation point of the gaze direction of the user is within a gaze zone area represented by four corner points in the camera coordinate system). The type of gaze zone associated with the gaze direction of the user, if any, may provide insight into whether or not the user is distracted and thus whether further action should be taken to alert the user. In some cases, the user may be a driver of a vehicle and the alert may serve to re-direct the driver's attention towards driving the vehicle, at least to improve the safety of the driver and, in some cases, other individuals on the road.

### Aspects Related to Gaze Direction Adjustment Based on Head Location

In certain aspects, the gaze direction of each user associated with each gaze zone, as well as the gaze direction estimated for a user (e.g., not yet associated with a gaze zone), may be adjusted to compensate for differences in head location of each user. For example, the pitch angles and yaw angles of users associated with a gaze zone may correspond to different head locations with respect to a same image sensor, such as a camera (e.g., one head location may be closer to the image sensor than another head location). To compensate for the differences in head location with respect to the camera, the yaw angles and pitch angles for the users associated with each gaze zone may be adjusted such that the pitch angles and yaw angles correspond to a same location with respect to the camera (e.g., with a same distance from the camera).

Additionally, a gaze direction estimated (e.g., estimate according to steps 202-214 in FIG. 2) for a user (e.g., not yet associated with a gaze zone), and represented as a pitch angle and a yaw angle, may be adjusted such that the pitch and yaw angles are representative of a pitch angle and a yaw angle, respectively, at an average head location for a gaze zone, at least prior to determining the Gaussian response for the gaze zone.

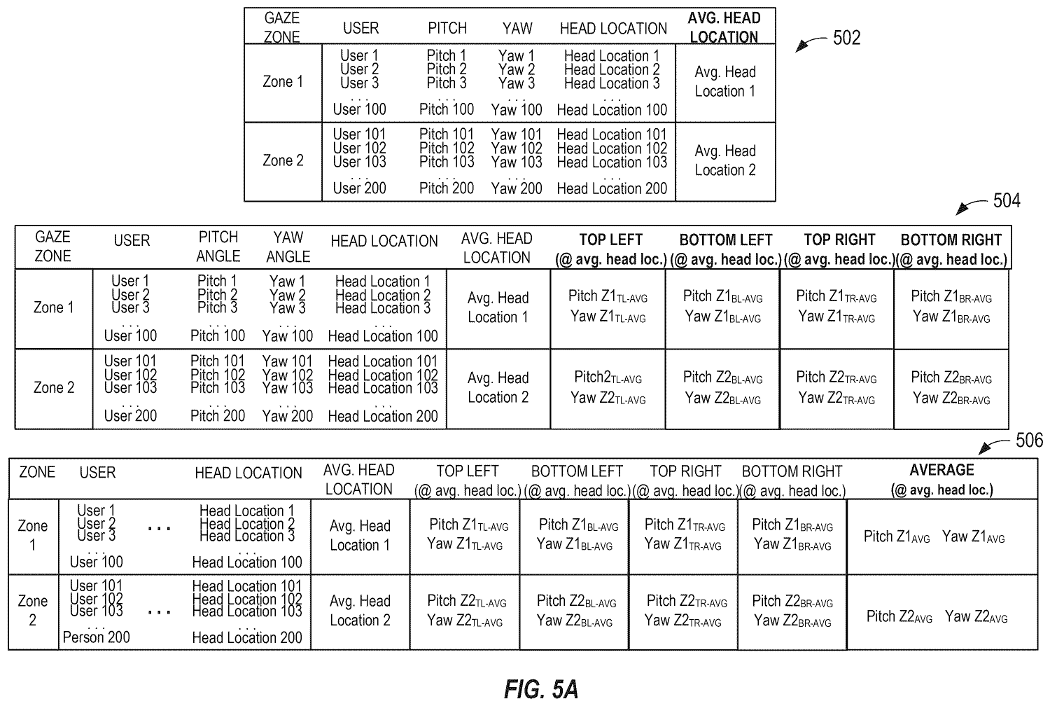

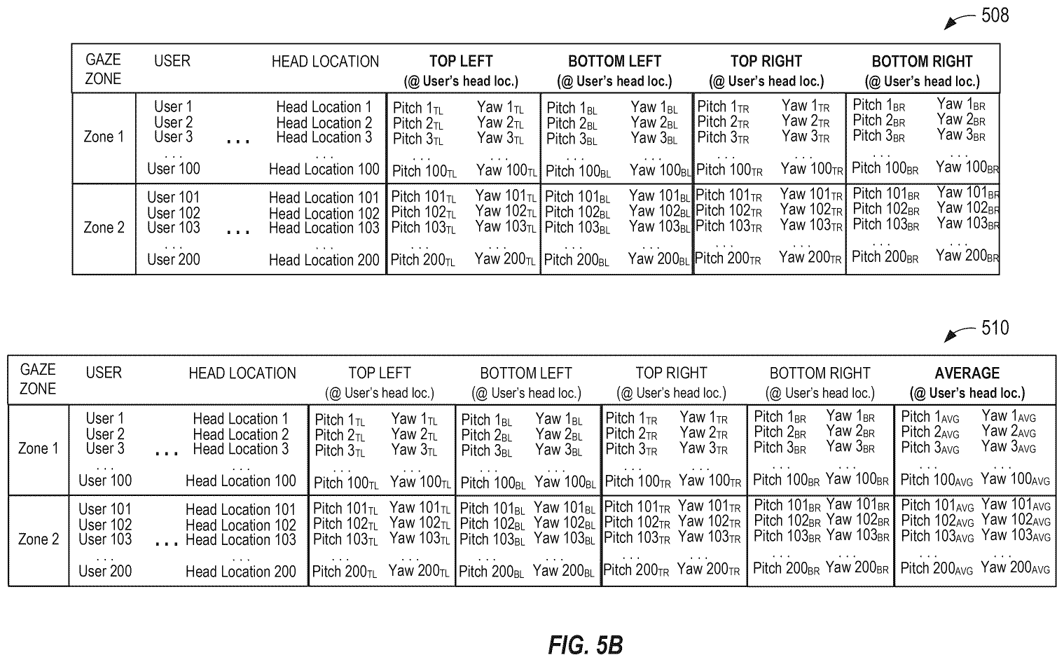

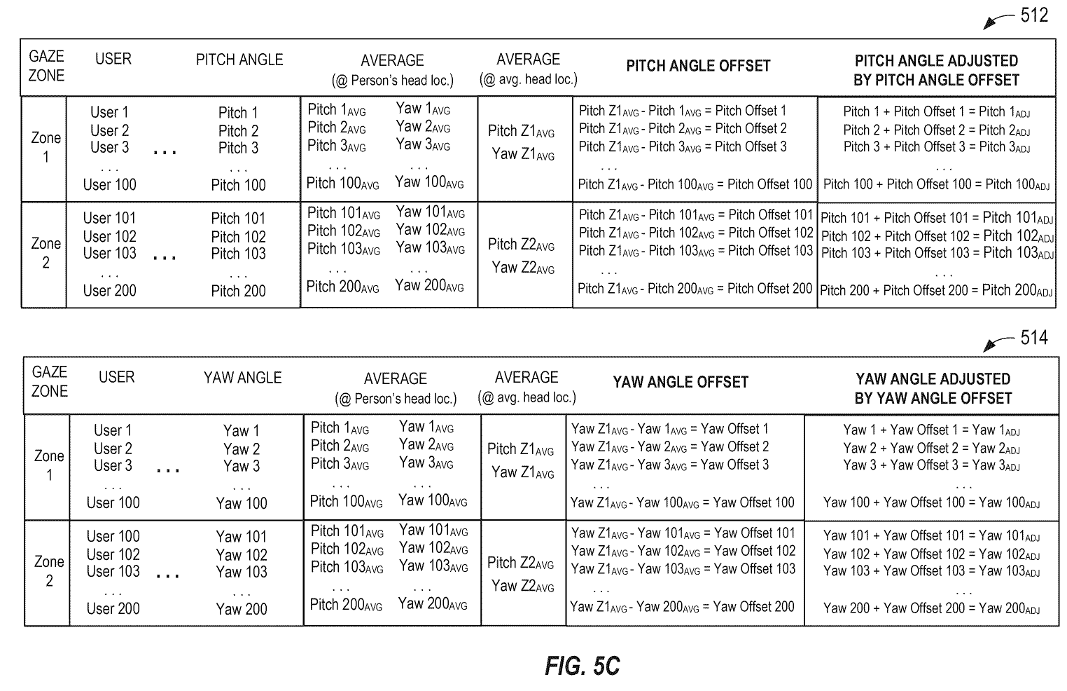

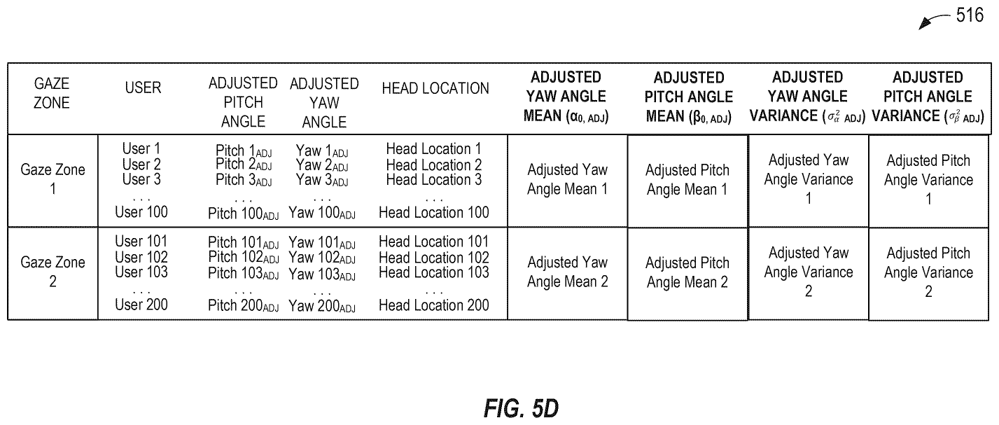

FIGS. 5A-5D depict such gaze direction adjustment based on head location. For example, FIGS. 5A-5D depict example adjustment of gaze directions, represented as pitch angles and yaw angles, for users associated with each gaze zone. The adjusted gaze direction may be subsequently used to determine a Gaussian response for each gaze zone (e.g., such as determination of the Gaussian response per gaze zone at 216 in FIG. 2).

Although FIGS. 5A-5D depict adjustment for only two gaze zones, similar techniques for adjusting the gaze directions, represented as pitch and yaw angles, may be applied per gaze zone for more than two gazes.

As shown in FIG. 5A, 100 gaze directions for 100 users, represented as Pitch 1-100 and Yaw 1-100, may be associated with gaze zone 1. The gaze directions associated with gaze zone 1 may correspond to head locations 1-100. Further, 100 gaze directions for another 100 users, represented as Pitch 101-200 and Yaw 101-200, may be associated with gaze zone 2. The gaze directions associated with gaze zone 2 may be associated with head locations 101-200.

The adjustment begins, at 502, with an average head location being determined for each of gaze zone 1 and gaze zone 2. For example, average head location 1, associated with gaze zone 1, may be determined by averaging the head locations 1-100. Similarly, average head location 2, associated with gaze zone 2, may be determined by averaging the head locations 101-200.

Next, at 504, a gaze direction towards each of the four corners, representing each gaze zone (e.g., such as corners 104-1 through 104-4 for gaze zone 102 in FIG. 1), may be determined for the average head location. For example, for gaze zone 1 (Z1), (1) a top left (TL) corner gaze direction of a user at average head location 1 may be determined (e.g., represented as Pitch Z1_{TL-AVG} and Yaw Z1_{TL-AVG}), (2) a bottom left (BL) corner gaze direction of a user at average head location 1 may be determined (e.g., represented as Pitch Z1_{BL-AVG} and Yaw Z1_{BL-AVG}), (3) a top right (TR) corner gaze direction of a user at average head location 1 may be determined (e.g., represented as Pitch Z1_{TR-AVG} and Yaw Z1_{TR-AVG}), and (4) a bottom right (BR) corner gaze direction of a user at average head location 1 may be determined (e.g., represented as Pitch Z1_{BR-AVG} and Yaw Z1_{BR-AVG}). Similarly, for gaze zone 2 (Z2), (1) a top left corner gaze direction of a user at average head location 2 may be determined (e.g., represented as Pitch Z2_{TL-AVG} and Yaw Z2_{TL-AVG}), (2) a bottom left corner gaze direction of a user at average head location 2 may be determined (e.g., represented as Pitch Z2_{BL-AVG} and Yaw Z2_{BL-AVG}), (3) a top right corner gaze direction of a user at average head location 2 may be determined (e.g., represented as Pitch Z2_{TR-AVG} and Yaw Z2_{TR-AVG}), and (4) a bottom right corner gaze direction of a user at average head location 2 may be determined (e.g., represented as Pitch Z2_{BR-AVG} and Yaw Z2_{BR-AVG}).

At 506, the pitch angle at each of the four corners of each gaze zone (e.g., top left, bottom left, top right, bottom right) may be averaged. Further, the yaw angle at each of the four corners of each gaze zone may be averaged. For example, for gaze zone 1, Pitch Z1_{TL-AVG}, Pitch Z1_{BL-AVG}, Pitch Z1_{TR-AVG}, and Pitch Z1_{BR-AVG} may be averaged to determine Pitch Z1_{AVG}. Additionally, for gaze zone 1, Yaw Z1_{TL-AVG}, Yaw Z1_{BL-AVG}, Yaw Z1_{TR-AVG}, and Yaw Z1_{BR-AVG} may be averaged to determine Yaw Z1_{AVG}. Similar steps may be performed to determine Pitch Z2_{AVG} and Yaw Z2_{AVG} for gaze zone 2.

At 508 (e.g., shown in FIG. 5B), a gaze direction towards each of the four corners, representing each gaze zone (e.g., such as corners 104-1 through 104-4 for gaze zone 102 in FIG. 1), may be determined for the head location of each user. For example, for user 1 and gaze zone 1, (1) a top left corner gaze direction of user 1 at head location 1 may be determined (e.g., represented as Pitch 1_{TL} and Yaw 1_{TL}), (2) a bottom left corner gaze direction of user 1 at head location 1 may be determined (e.g., represented at Pitch 1_{BL} and Yaw 1_{BL}), (3) a top right corner gaze direction of user 1 at head location 1 may be determined (e.g., represented as Pitch 1_{TR} and Yaw 1_{TR}), and (4) a bottom right corner gaze direction of user 1 at head location 1 may be determined (e.g., represented as Pitch 1_{BR} and Yaw 1_{BR}). Similar steps may be performed for each of users 2-100 associated with gaze zone 1.

Further, for user 101 and gaze zone 2, (1) a top left corner gaze direction of user 101 at head location 101 may be determined (e.g., represented as Pitch 101_{TL} and Yaw 101_{TL}), (2) a bottom left corner gaze direction of user 101 at head location 101 may be determined (e.g., represented at Pitch 101_{BL} and Yaw 101_{BL}), (3) a top right corner gaze direction of user 101 at head location 101 may be determined (e.g., represented as Pitch 101_{TR} and Yaw 101_{TR}), and (4) a bottom right corner gaze direction of user 101 at head location 101 may be determined (e.g., represented as Pitch 101_{BR} and Yaw 101_{BR}). Similar steps may be performed for each of users 102-200 associated with gaze zone 2.

At 510, the pitch angle at each of the four corners of a respective gaze zone (e.g., top left, bottom left, top right, bottom right) associated with each user may be averaged. Further, the pitch angle at each of the four corners of a respective gaze zone associated with each user may be averaged. For example, for user 1 associated with gaze zone 1, Pitch 1_{TL}, Pitch 1_{BL}, Pitch 1_{TR}, and Pitch 1_{BR} may be averaged to determine Pitch 1_{AVG}. Additionally, for gaze zone 1, Yaw 1_{TL}, Yaw 1_{BL}, Yaw 1_{TR}, and Yaw 1_{BR} may be averaged to determine Yaw 1_{AVG}. Similar steps may be performed to determine pitch and yaw averages at each user's particular head location.

At 512 in FIG. 5C, a pitch angle offset is calculated for each user as the average pitch angle of a gaze zone corresponding to the respective user (e.g., determined at 506 in FIG. 5A) minus the average pitch angle of the respective user (e.g., determined at 510 in FIG. 5B). The pitch angle offset determined for each user may be used to adjust the pitch angle for each user. For example, a pitch angle offset determined for user 1 may be (Pitch Z1_{AVG})−(Pitch 1_{AVG}). This pitch angle offset may then be used to adjust Pitch 1 associated with user 1 to generate an adjusted pitch angle for user 1, Pitch 1_{ADJ} (e.g., Pitch 1+Pitch Offset 1=Pitch 1_{ADJ}). Similar steps may be performed for each of users 2-200.

At 514, a yaw angle offset is calculated for each user as the average yaw angle of a gaze zone corresponding to the respective user (e.g., determined at 506 in FIG. 5A) minus the average yaw angle of the respective user (e.g., determined at 510 in FIG. 5B). The yaw angle offset determined for each user may be used to adjust the yaw angle for each user. For example, a yaw angle offset determined for user 1 may be (Yaw Z1_{AVG})−(Yaw 1_{AVG}). This yaw angle offset may then be used to adjust Yaw 1 associated with user 1 to generate an adjusted yaw angle for user 1, Yaw 1_{ADJ} (e.g., Yaw 1+Yaw Offset 1=Yaw 1_{ADJ}). Similar steps may be performed for each of users 2-200.

At 516 in FIG. 5D, the adjusted pitch angles may be used to calculate an adjusted pitch angle mean and an adjusted pitch angle variance for each gaze zone. Further, the adjusted yaw angles may be used to calculate an adjusted yaw angle mean and an adjusted yaw angle variance for each gaze zone. The adjusted pitch angle mean, the adjusted pitch angle variance, the adjusted yaw angle mean, and the adjusted yaw angle variance for a gaze zone may be used to determine an adjusted Gaussian distribution for the gaze zone.

For example, for gaze zone 1, adjusted pitch angle mean 1 may be calculated as the average of adjusted pitches 1-100, and adjusted yaw angle mean 1 may be calculated as the average of adjusted yaws 1-100. Adjusted pitch angle variance 1 may be calculated as the variance of adjusted pitches 1-100, and adjusted yaw angle variance 1 may be calculated as the variance of adjusted yaws 1-100. An adjusted Gaussian distribution for gaze zone 1 may be determined based at least in part on adjusted pitch angle mean 1, adjusted yaw angle mean 1, adjusted pitch angle variance 1, and adjusted yaw angle variance 1. Similar steps may be taken to determine an adjusted Gaussian distribution for gaze zone 2.

In addition to adjusting the gaze directions of users associated with each gaze zone, the gaze direction (g_{c}) estimated for a user in the camera coordinate system may also be adjusted. For example, gaze direction (g_{c}) represented as pitch angle (β) and yaw angle (α), may be adjusted similar to how the pitch angle and yaw angle is adjusted for each user associated with each gaze zone, as described above with respect to steps 508-514 in FIGS. 5B and 5C.

For example, for each gaze zone, a gaze direction towards each of the four corners of the respective gaze zone, may be determined for the head location of the user. A pitch angle at each of the four corners of the gaze zone (e.g., top left, bottom left, top right, bottom right) may be averaged. Further, the yaw angle at each of the four corners of the gaze zone may be averaged. A pitch angle offset, associated with the user and the gaze zone, may be calculated as the average pitch angle of the gaze zone (e.g., determined at 506 in FIG. 5A) minus the average pitch angle of the user. A yaw angle offset, associated with the user and the gaze zone, may be calculated as the average yaw angle of the gaze zone (e.g., determined at 506 in FIG. 5A) minus the average yaw angle of the user.

This pitch angle offset (β offset) may then be used to adjust the pitch angle (β) for the user to generate an adjusted pitch angle (Padj) for the user (β_{adj}=β+β offset) and the gaze zone. Further, the yaw angle offset (α offset) may then be used to adjust the yaw angle (α) for the user to generate an adjusted yaw angle (α_{adj}) (α_{adj}=α+α offset) for the user and the gaze zone.

A Gaussian response for the gaze zone may then be determined according to the equation:

$$f ( {α}_{adj} , {β}_{adj} ) = A exp ( - ( \frac{{( {α}_{adj} - {α}_{0 , adj} )}^{2}}{2 {σ}_{α , adj}^{2}} ) + ( \frac{{( {β}_{adj} - {β}_{0 , adj} )}^{2}}{2 {σ}_{β , adj}^{2}} ) )$$

Similar steps may be performed to adjust the gaze direction (g_{c}), represented as pitch angle (β) and yaw angle (α), for each gaze zone to determine an adjusted Gaussian response for each gaze zone.

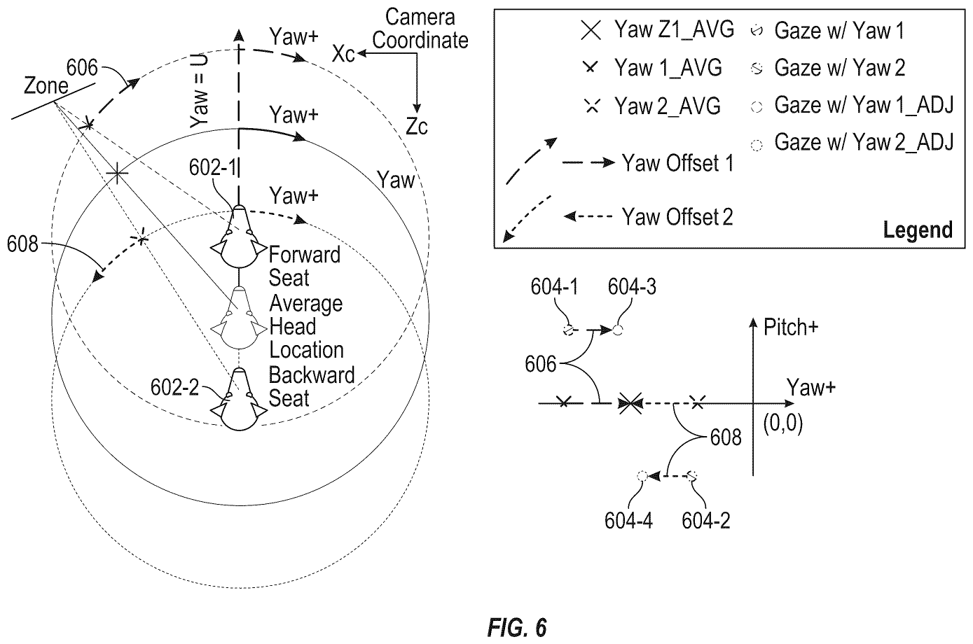

FIG. 6 depicts example yaw angle (α) adjustment. For example, as shown in FIG. 6, a first user 602-1, having a gaze direction associated with a first gaze zone, may correspond to a head location forward of an average head location (e.g., closer to an image sensor) determined for the first gaze zone. Further, a second user 602-2, having a gaze direction associated with the first gaze zone, may correspond to a head location backwards of the average head location determined for the first gaze zone (e.g., further away from an image sensor). To compensate for differences in head location, (1) a first gaze direction, represented as at least a first yaw angle 604-1 for first user 602-1, may be adjusted and (2) a second gaze direction, represented as at least a second yaw angle 604-2 for second user 602-2, may be adjusted.

For example, first yaw angle 604-1 may be adjusted to third yaw angle 604-3 (e.g., arrows 606 represent the yaw offset 606 used to compensate for differences between the head location of first user 602-1 and the average head location). Additionally, second yaw angle 604-2 may be adjusted to a fourth yaw angle 604-4 (e.g., arrows 608 represent the yaw offset 608 used to compensate for differences between the head location of second user 602-2 and the average head location).

More specifically, the regular X in FIG. 6 may represent the average yaw angle for the first gaze zone, associated with the average head location in the first gaze zone (e.g., Yaw Z1_{AVG}). Further, the bolded X may represent the average yaw angle (e.g., Yaw 1_{AVG}) for the first gaze zone, associated with the head location of the first user 602-1, and the dashed X may represent the average yaw angle (e.g., Yaw 2_{AVG}) for the first gaze zone, associated with the head location of the second user 602-2.

The yaw offset 606 determined for the first user 602-1 may be calculated as:

$$Yaw Offset 606 = Yaw Z {1}_{AVG} - Yaw {1}_{AVG}$$

and the yaw offset 608 determined for the second user 602-2 may be calculated as:

$$Yaw Offset 608 = Yaw Z {1}_{AVG} - Yaw {2}_{AVG}$$

In this example, yaw offset 606 may be a positive (+) value. Accordingly, the first user 602-1's yaw angle may be adjusted rightward from first yaw angle 604-1 to third yaw angle 604-3. Further, in this example, yaw offset 608 may be a negative (−) value. Accordingly, the second user 602-2's yaw angle may be adjusted leftward from second yaw angle 604-2 to fourth yaw angle 604-4.

Although FIG. 6 depicts only adjustment to gaze direction yaw angles, in some other example, gaze directions pitch angles may be additionally adjusted to account for differences in head locations of different users.

### Example Method for Gaze Zone Detection

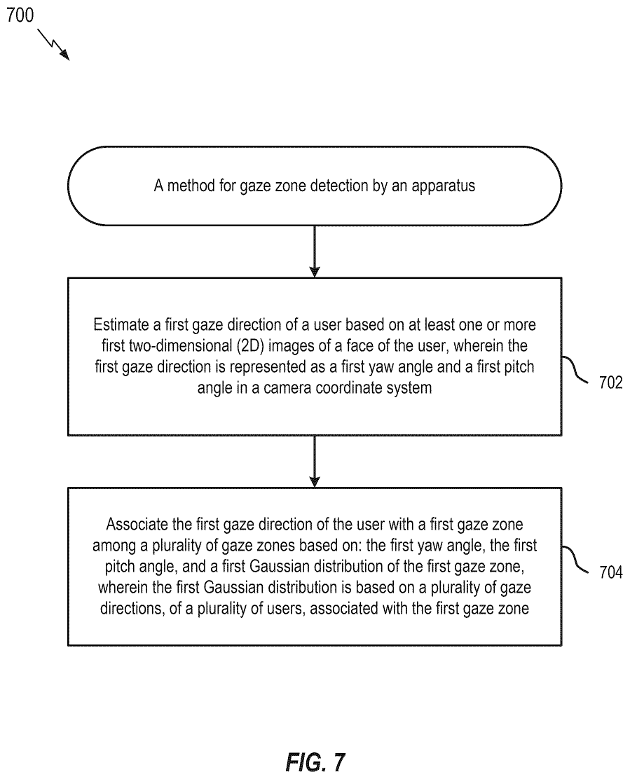

FIG. 7 shows a method 700 for gaze zone detection by an apparatus. For example, the apparatus may estimate the gaze direction of a user and determine which gaze zone, if any, is associated with the estimated gaze direction of the user.

Method 700 begins, at block 702, with estimating a first gaze direction of a user based on at least one or more first 2D images of a face of the user. The first gaze direction may be represented as a first yaw angle and a first pitch angle in a camera coordinate system.

Method 700 then proceeds, to block 704, with associating the first gaze direction of the user with a first gaze zone among a plurality of gaze zones based on: the first yaw angle; the first pitch angle; and a first Gaussian distribution of the first gaze zone. The first Gaussian distribution may be based on a plurality of gaze directions, of a plurality of users, associated with the first gaze zone.

In one aspect, method 700 further comprises adjusting the first yaw angle by a first offset to generate a second yaw angle in the camera coordinate system; and adjusting the first pitch angle by a second offset to generate a second pitch angle in the camera coordinate system, wherein associating the first gaze direction of the user with the first gaze zone comprises associating the first gaze direction of the user with a first gaze zone based on the second yaw angle and the second pitch angle.

In one aspect, the one or more first 2D images correspond to a head of the user in a first location. In one aspect, method 700 further comprises collecting one or more second 2D images of the face of the user corresponding to the head of the user in a second location different from the first location; estimating a second gaze direction of the user based on at least the one or more second 2D images, wherein the second gaze direction is represented as a third yaw angle and a third pitch angle in a camera coordinate system; and associating the second gaze direction of the user with the first gaze zone based on: the third yaw angle; the third pitch angle; and the first Gaussian distribution of the first gaze zone.

In one aspect, the first gaze zone comprises a first top left corner, a first top right corner, a first bottom left corner, and a first bottom right corner. In one aspect, the one or more first 2D images correspond to a head of the user in a first location. In one aspect, method 700 further comprises: for the head of the user in the first location: determining a top left corner gaze direction of the user towards the first top left corner, wherein the top left corner gaze direction is represented as a top left corner yaw angle and a top left corner pitch angle in the camera coordinate system; determining a top right corner gaze direction of the user towards the first top right corner, wherein the top right corner gaze direction is represented as a top right corner yaw angle and a top right corner pitch angle in the camera coordinate system; determining a bottom left corner gaze direction of the user towards the first bottom left corner, wherein the bottom left corner gaze direction is represented as a bottom left corner yaw angle and a bottom left corner pitch angle in the camera coordinate system; determining a bottom right corner gaze direction of the user towards the first bottom right corner, wherein the bottom right corner gaze direction is represented as a bottom right corner yaw angle and a bottom right corner pitch angle in the camera coordinate system; determining an average yaw angle for the user corresponding to the first gaze zone based on the top left corner yaw angle, the top right corner yaw angle, the bottom left corner yaw angle, and the bottom right corner yaw angle; and determining an average pitch angle for the user corresponding to the first gaze zone based on the top left corner pitch angle, the top right corner pitch angle, the bottom left corner pitch angle, and the bottom right corner pitch angle; determining the first offset based on a difference between an average first zone yaw angle corresponding to an average head location of the plurality of users and the average yaw angle for the user; and determining the second offset based on a difference between an average first zone pitch angle corresponding to the average head location of the plurality of users and the average yaw angle for the user.

In one aspect, method 700 further comprises: determining the average head location of the plurality of users; for the average head location of the plurality of users: determining a first gaze zone top left corner gaze direction towards the first top left corner, wherein the first gaze zone top left corner gaze direction is represented as a first gaze zone top left corner yaw angle and a first gaze zone top left corner pitch angle in the camera coordinate system; determining a first gaze zone top right corner gaze direction towards the first top right corner, wherein the first gaze zone top right corner gaze direction is represented as a first gaze zone top right corner yaw angle and a first gaze zone top right corner pitch angle in the camera coordinate system; determining a first gaze zone bottom left corner gaze direction towards the first bottom left corner, wherein the first gaze zone bottom left corner gaze direction is represented as a first gaze zone bottom left corner yaw angle and a first gaze zone bottom left corner pitch angle in the camera coordinate system; and determining a first gaze zone bottom right corner gaze direction towards the first bottom right corner, wherein the first gaze zone bottom right corner gaze direction is represented as a first gaze zone bottom right corner yaw angle and a first gaze zone bottom right corner pitch angle in the camera coordinate system; determining the average first zone yaw angle corresponding to the average head location of the plurality of users based on the first gaze zone top left corner yaw angle, the first gaze zone top right corner yaw angle, the first gaze zone bottom left corner yaw angle, and the first gaze zone bottom right corner yaw angle; and determining the average first zone pitch angle corresponding to the average head location of the plurality of users based on the first gaze zone top left corner pitch angle, the first gaze zone top right corner pitch angle, the first gaze zone bottom left corner pitch angle, and the first gaze zone bottom right corner pitch angle.

In one aspect, the plurality of gaze directions of the plurality of users are represented as a plurality of second yaw angles and a plurality of second pitch angles in the camera coordinate system. In one aspect, method 700 further comprises: for each respective gaze direction of each respective user: adjusting the respective second yaw angle of the respective gaze direction by a respective first offset to generate a respective third yaw angle in the camera coordinate system, wherein the respective first offset is associated with the respective user; and adjusting the respective second pitch angle of the respective gaze direction by a respective second offset to generate a respective third pitch angle in the camera coordinate system, wherein the respective second offset is associated with the respective user.

In one aspect, the first gaze zone comprises a first top left corner, a first top right corner, a first bottom left corner, and a first bottom right corner. In one aspect, method 700 further comprises, for a respective head location of each respective user: determining a respective top left corner gaze direction of the respective user towards the first top left corner, wherein the respective top left corner gaze direction is represented as a respective top left corner yaw angle and a respective top left corner pitch angle in the camera coordinate system; determining a respective top right corner gaze direction of the respective user towards the first top right corner, wherein the respective top right corner gaze direction is represented as a respective top right corner yaw angle and a respective top right corner pitch angle in the camera coordinate system; determining a respective bottom left corner gaze direction of the respective user towards the first bottom left corner, wherein the respective bottom left corner gaze direction is represented as a respective bottom left corner yaw angle and a respective bottom left corner pitch angle in the camera coordinate system; and determining a respective bottom right corner gaze direction of the respective user towards the first bottom right corner, wherein the respective bottom right corner gaze direction is represented as a respective bottom right corner yaw angle and a respective bottom right corner pitch angle in the camera coordinate system; determining a respective average yaw angle for the respective user corresponding to the first gaze zone based on the respective top left corner yaw angle, the respective top right corner yaw angle, the respective bottom left corner yaw angle, and the respective bottom right corner yaw angle; and determining a respective average pitch angle for the respective user corresponding to the first gaze zone based on the respective top left corner pitch angle, the respective top right corner pitch angle, the respective bottom left corner pitch angle, and the respective bottom right corner pitch angle; and for each respective user: determining the respective first offset based on a difference between an average first zone yaw angle corresponding to an average head location of the plurality of users and the respective average yaw angle for the respective user; and determining the respective second offset based on a difference between an average first zone pitch angle corresponding to the average head location of the plurality of users and the respective average yaw angle for the respective user.

In one aspect, method 700 further comprises determining a yaw angle mean for a plurality of third yaw angles comprising the respective third yaw angle of each respective user; determining a pitch angle mean for a plurality of third pitch angles comprising the respective third pitch angle of each respective user; determining a yaw angle variance for the plurality of third yaw angles; determining a pitch angle variance for the plurality of third pitch angles; and determining the first Gaussian distribution of the first gaze zone based on the yaw angle mean, the pitch angle mean, the yaw angle variance, and the pitch angle variance.

In one aspect, the plurality of gaze directions of the plurality of users are represented as a plurality of yaw angles and a plurality of pitch angles in the camera coordinate system; and the method further comprises: determining a yaw angle mean for the plurality of yaw angles; determining a pitch angle mean for the plurality of pitch angles; determining a yaw angle variance for the plurality of yaw angles; determining a pitch angle variance for the plurality of pitch angles; and determining the first Gaussian distribution of the first gaze zone based on the yaw angle mean, the pitch angle mean, the yaw angle variance, and the pitch angle variance.

In one aspect, the plurality of gaze directions of the plurality of users correspond to at least one of: a plurality of user heights; or a plurality of user sitting positions.

In one aspect, associating the first gaze direction of the user with the first gaze zone at block 704 comprises: for each respective gaze zone of the plurality of gaze zones, determining a Gaussian response based on: the first yaw angle; the first pitch angle; and a Gaussian distribution of the respective gaze zone; and associating the first gaze direction of the user with the first gaze zone based on the first gaze zone having a greatest Gaussian response among the plurality of gaze zones.

In one aspect, estimating the first gaze direction of the user comprises: reconstructing a 3D face model for the user based on at least one of the one or more first 2D images of the face of the user; estimating a head pose of the user using the 3D face model; identifying one or more facial landmarks of the user corresponding to one or more eye locations of the user using the 3D face model; normalizing eye image patches associated with the user to generate a fixed-size eye image patch pair using the one or more facial landmarks identified for the user; processing, using a gaze estimation network, the head pose and the fixed-size eye image patch pair to estimate a second gaze direction of the user in a head coordinate system; estimating a head position of the user using the 3D face model; and estimating the first gaze direction of the user in the camera coordinate system based on the head position and the second gaze direction of the user in the head coordinate system.

Note that FIG. 7 is just one example of a method, and other methods including fewer, additional, or alternative operations are possible consistent with this disclosure.

### Example Device for Gaze Zone Detection

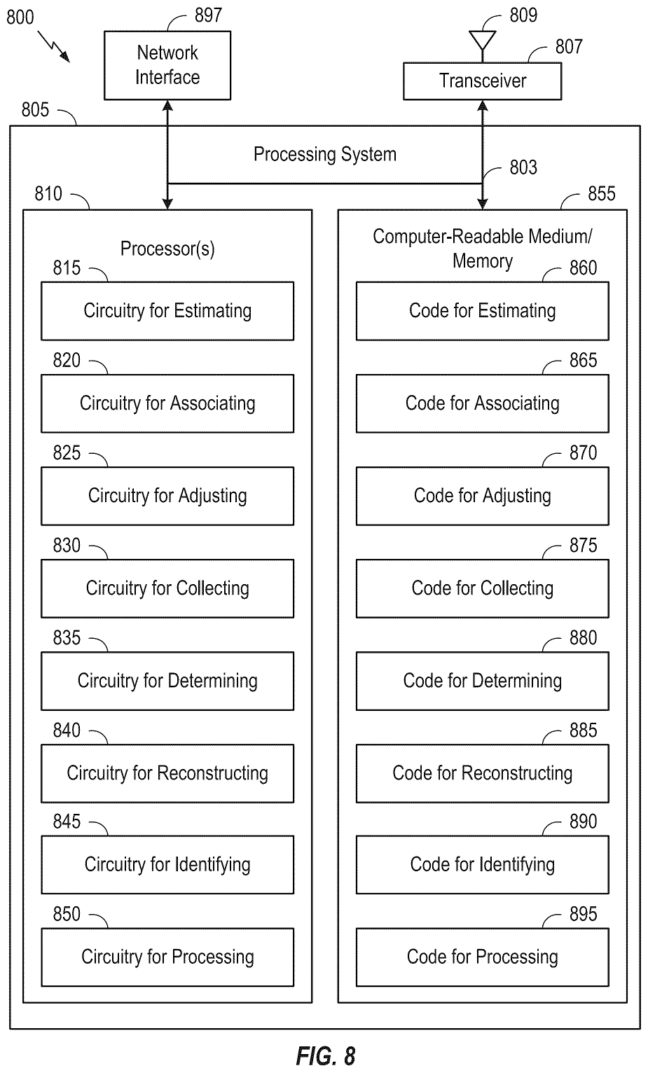

FIG. 8 depicts aspects of an example device 800 configured to perform gaze zone detection.

Device 800 includes a processing system 805 that may be coupled to a transceiver 807 (e.g., a transmitter and/or a receiver) and/or a network interface 897. The transceiver 807 may be configured to transmit and receive signals for the device 800 via an antenna 809, such as the various signals as described herein. The network interface 897 may be configured to obtain and send signals for the device 800 via communications link(s).

The processing system 805 includes one or more processors 810. The one or more processors 810 are coupled to a computer-readable medium/memory 855 via a bus 803. In certain aspects, the computer-readable medium/memory 855 is configured to store instructions (e.g., computer-executable code), including code 860-895, that when executed by the one or more processors 810, enable and cause the one or more processors 810 to perform the method 700 described with respect to FIG. 7, or any aspect related to it, including any operations described in relation to FIG. 7. Note that reference to a processor of device 800 performing a function may include one or more processors of device 800 performing that function, such as in a distributed fashion.

In the depicted example, the computer-readable medium/memory 855 stores code for estimating 860, code for associating 865, code for adjusting 870, code for collecting 875, code for determining 880, code for reconstructing 885, code for identifying 890, and code for processing 895. Processing of the code 860-895 may enable and cause the device 800 to perform the method 700 described with respect to FIG. 7, or any aspect related to it.

The one or more processors 810 include circuitry configured to implement (e.g., execute) the code (e.g., executable instructions) stored in the computer-readable medium/memory 855, including circuitry for estimating 815, circuitry for associating 820, circuitry for adjusting 825, circuitry for collecting 830, circuitry for determining 835, circuitry for reconstructing 840, circuitry for identifying 845, and circuitry for processing 850. Processing with circuitry 815-850 may enable and cause the device 800 to perform the method 700 described with respect to FIG. 7, or any aspect related to it.

Various components of the device 800 may provide means for performing the method 700 described with respect to FIG. 7, or any aspect related to it. For example, means for estimating, associating, adjusting, collecting, determining, reconstructing, identifying, and processing of the method 700 described with respect to FIG. 7, or any aspect related to it may include one or more processors 810 of the device 800 in FIG. 8.

### Example Clauses

Implementation examples are described in the following numbered clauses:

Clause 1: A method by an apparatus comprising: estimating a first gaze direction of a user based on at least one or more first 2D images of a face of the user, wherein the first gaze direction is represented as a first yaw angle and a first pitch angle in a camera coordinate system; and associating the first gaze direction of the user with a first gaze zone among a plurality of gaze zones based on: the first yaw angle; the first pitch angle; and a first Gaussian distribution of the first gaze zone, wherein the first Gaussian distribution is based on a plurality of gaze directions, of a plurality of users, associated with the first gaze zone.

Clause 2: The method of Clause 1, further comprising: adjusting the first yaw angle by a first offset to generate a second yaw angle in the camera coordinate system; and adjusting the first pitch angle by a second offset to generate a second pitch angle in the camera coordinate system, wherein associating the first gaze direction of the user with the first gaze zone comprises associating the first gaze direction of the user with a first gaze zone based on the second yaw angle and the second pitch angle.

Clause 3: The method of Clause 2, wherein: the one or more first 2D images correspond to a head of the user in a first location; and the method further comprises: collecting one or more second 2D images of the face of the user corresponding to the head of the user in a second location different from the first location; estimating a second gaze direction of the user based on at least the one or more second 2D images, wherein the second gaze direction is represented as a third yaw angle and a third pitch angle in a camera coordinate system; and associating the second gaze direction of the user with the first gaze zone based on: the third yaw angle; the third pitch angle; and the first Gaussian distribution of the first gaze zone.

Clause 4: The method of any one of Clauses 2-3, wherein: the first gaze zone comprises a first top left corner, a first top right corner, a first bottom left corner, and a first bottom right corner; the one or more first 2D images correspond to a head of the user in a first location; the method further comprises: for the head of the user in the first location: determining a top left corner gaze direction of the user towards the first top left corner, wherein the top left corner gaze direction is represented as a top left corner yaw angle and a top left corner pitch angle in the camera coordinate system; determining a top right corner gaze direction of the user towards the first top right corner, wherein the top right corner gaze direction is represented as a top right corner yaw angle and a top right corner pitch angle in the camera coordinate system; determining a bottom left corner gaze direction of the user towards the first bottom left corner, wherein the bottom left corner gaze direction is represented as a bottom left corner yaw angle and a bottom left corner pitch angle in the camera coordinate system; determining a bottom right corner gaze direction of the user towards the first bottom right corner, wherein the bottom right corner gaze direction is represented as a bottom right corner yaw angle and a bottom right corner pitch angle in the camera coordinate system; determining an average yaw angle for the user corresponding to the first gaze zone based on the top left corner yaw angle, the top right corner yaw angle, the bottom left corner yaw angle, and the bottom right corner yaw angle; and determining an average pitch angle for the user corresponding to the first gaze zone based on the top left corner pitch angle, the top right corner pitch angle, the bottom left corner pitch angle, and the bottom right corner pitch angle; determining the first offset based on a difference between an average first zone yaw angle corresponding to an average head location of the plurality of users and the average yaw angle for the user; and determining the second offset based on a difference between an average first zone pitch angle corresponding to the average head location of the plurality of users and the average yaw angle for the user.

Clause 5: The method of Clause 4, further comprising: determining the average head location of the plurality of users; for the average head location of the plurality of users: determining a first gaze zone top left corner gaze direction towards the first top left corner, wherein the first gaze zone top left corner gaze direction is represented as a first gaze zone top left corner yaw angle and a first gaze zone top left corner pitch angle in the camera coordinate system; determining a first gaze zone top right corner gaze direction towards the first top right corner, wherein the first gaze zone top right corner gaze direction is represented as a first gaze zone top right corner yaw angle and a first gaze zone top right corner pitch angle in the camera coordinate system; determining a first gaze zone bottom left corner gaze direction towards the first bottom left corner, wherein the first gaze zone bottom left corner gaze direction is represented as a first gaze zone bottom left corner yaw angle and a first gaze zone bottom left corner pitch angle in the camera coordinate system; and determining a first gaze zone bottom right corner gaze direction towards the first bottom right corner, wherein the first gaze zone bottom right corner gaze direction is represented as a first gaze zone bottom right corner yaw angle and a first gaze zone bottom right corner pitch angle in the camera coordinate system; determining the average first zone yaw angle corresponding to the average head location of the plurality of users based on the first gaze zone top left corner yaw angle, the first gaze zone top right corner yaw angle, the first gaze zone bottom left corner yaw angle, and the first gaze zone bottom right corner yaw angle; and determining the average first zone pitch angle corresponding to the average head location of the plurality of users based on the first gaze zone top left corner pitch angle, the first gaze zone top right corner pitch angle, the first gaze zone bottom left corner pitch angle, and the first gaze zone bottom right corner pitch angle.

Clause 6: The method of any one of Clauses 1-5, wherein: the plurality of gaze directions of the plurality of users are represented as a plurality of second yaw angles and a plurality of second pitch angles in the camera coordinate system; and the method further comprises: for each respective gaze direction of each respective user: adjusting the respective second yaw angle of the respective gaze direction by a respective first offset to generate a respective third yaw angle in the camera coordinate system, wherein the respective first offset is associated with the respective user; and adjusting the respective second pitch angle of the respective gaze direction by a respective second offset to generate a respective third pitch angle in the camera coordinate system, wherein the respective second offset is associated with the respective user.

Clause 7: The method of clause 6, wherein: the first gaze zone comprises a first top left corner, a first top right corner, a first bottom left corner, and a first bottom right corner; the method further comprises: for a respective head location of each respective user: determining a respective top left corner gaze direction of the respective user towards the first top left corner, wherein the respective top left corner gaze direction is represented as a respective top left corner yaw angle and a respective top left corner pitch angle in the camera coordinate system; determining a respective top right corner gaze direction of the respective user towards the first top right corner, wherein the respective top right corner gaze direction is represented as a respective top right corner yaw angle and a respective top right corner pitch angle in the camera coordinate system; determining a respective bottom left corner gaze direction of the respective user towards the first bottom left corner, wherein the respective bottom left corner gaze direction is represented as a respective bottom left corner yaw angle and a respective bottom left corner pitch angle in the camera coordinate system; and determining a respective bottom right corner gaze direction of the respective user towards the first bottom right corner, wherein the respective bottom right corner gaze direction is represented as a respective bottom right corner yaw angle and a respective bottom right corner pitch angle in the camera coordinate system; determining a respective average yaw angle for the respective user corresponding to the first gaze zone based on the respective top left corner yaw angle, the respective top right corner yaw angle, the respective bottom left corner yaw angle, and the respective bottom right corner yaw angle; and determining a respective average pitch angle for the respective user corresponding to the first gaze zone based on the respective top left corner pitch angle, the respective top right corner pitch angle, the respective bottom left corner pitch angle, and the respective bottom right corner pitch angle; and for each respective user: determining the respective first offset based on a difference between an average first zone yaw angle corresponding to an average head location of the plurality of users and the respective average yaw angle for the respective user; and determining the respective second offset based on a difference between an average first zone pitch angle corresponding to the average head location of the plurality of users and the respective average yaw angle for the respective user.

Clause 8: The method of any one of Clauses 6-7, further comprising: determining a yaw angle mean for a plurality of third yaw angles comprising the respective third yaw angle of each respective user; determining a pitch angle mean for a plurality of third pitch angles comprising the respective third pitch angle of each respective user; determining a yaw angle variance for the plurality of third yaw angles; determining a pitch angle variance for the plurality of third pitch angles; and determining the first Gaussian distribution of the first gaze zone based on the yaw angle mean, the pitch angle mean, the yaw angle variance, and the pitch angle variance.

Clause 9: The method of any one of Clauses 1-8, wherein: the plurality of gaze directions of the plurality of users are represented as a plurality of yaw angles and a plurality of pitch angles in the camera coordinate system; and the method further comprises: determining a yaw angle mean for the plurality of yaw angles; determining a pitch angle mean for the plurality of pitch angles; determining a yaw angle variance for the plurality of yaw angles; determining a pitch angle variance for the plurality of pitch angles; and determining the first Gaussian distribution of the first gaze zone based on the yaw angle mean, the pitch angle mean, the yaw angle variance, and the pitch angle variance.

Clause 10: The method of any one of Clauses 1-9, wherein the plurality of gaze directions of the plurality of users correspond to at least one of: a plurality of user heights; or a plurality of user sitting positions.

Clause 11: The method of any one of Clauses 1-10, wherein associating the first gaze direction of the user with the first gaze zone comprises: for each respective gaze zone of the plurality of gaze zones, determining a Gaussian response based on: the first yaw angle; the first pitch angle; and a Gaussian distribution of the respective gaze zone; and associating the first gaze direction of the user with the first gaze zone based on the first gaze zone having a greatest Gaussian response among the plurality of gaze zones.

Clause 12: The method of any one of Clauses 1-11, wherein estimating the first gaze direction of the user comprises: reconstructing a 3D face model for the user based on at least one of the one or more first 2D images of the face of the user; estimating a head pose of the user using the 3D face model; identifying one or more facial landmarks of the user corresponding to one or more eye locations of the user using the 3D face model; normalizing eye image patches associated with the user to generate a fixed-size eye image patch pair using the one or more facial landmarks identified for the user; processing, using a gaze estimation network, the head pose and the fixed-size eye image patch pair to estimate a second gaze direction of the user in a head coordinate system; and estimating the first gaze direction of the user in the camera coordinate system based on the head position and the second gaze direction of the user in the head coordinate system.

Clause 13: One or more apparatuses, comprising: one or more memories comprising executable instructions; and one or more processors configured to execute the executable instructions and cause the one or more apparatuses to perform a method in accordance with any one of clauses 1-12.

Clause 14: One or more apparatuses, comprising: one or more memories; and one or more processors, coupled to the one or more memories, configured to cause the one or more apparatuses to perform a method in accordance with any one of Clauses 1-12.

Clause 15: One or more apparatuses, comprising: one or more memories; and one or more processors, coupled to the one or more memories, configured to perform a method in accordance with any one of Clauses 1-12.

Clause 16: One or more apparatuses, comprising means for performing a method in accordance with any one of Clauses 1-12.

Clause 17: One or more non-transitory computer-readable media comprising executable instructions that, when executed by one or more processors of one or more apparatuses, cause the one or more apparatuses to perform a method in accordance with any one of Clauses 1-12.

Clause 18: One or more computer program products embodied on one or more computer-readable storage media comprising code for performing a method in accordance with any one of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising:
one or more memories; and
one or more processors, coupled to the one or more memories, configured to cause the apparatus to:
estimate a first gaze direction of a user based on at least one or more first two-dimensional (2D) images of a face of the user, wherein the first gaze direction is represented as a first yaw angle and a first pitch angle in a camera coordinate system; and
associate the first gaze direction of the user with a first gaze zone among a plurality of gaze zones based on:
the first yaw angle;
the first pitch angle; and
a first Gaussian distribution of the first gaze zone, wherein the first Gaussian distribution is based on a plurality of gaze directions, of a plurality of users, associated with the first gaze zone.

2. The apparatus of claim 1, wherein:
the one or more processors are configured to cause the apparatus to:
adjust the first yaw angle by a first offset to generate a second yaw angle in the camera coordinate system; and
adjust the first pitch angle by a second offset to generate a second pitch angle in the camera coordinate system, and
to associate the first gaze direction of the user with the first gaze zone, the one or more processors are configured to cause the apparatus to associate the first gaze direction of the user with a first gaze zone based on the second yaw angle and the second pitch angle.

3. The apparatus of claim 2, wherein:
the one or more first 2D images correspond to a head of the user in a first location; and
the one or more processors are configured to cause the apparatus to:
collect one or more second 2D images of the face of the user corresponding to the head of the user in a second location different from the first location;
estimate a second gaze direction of the user based on at least the one or more second 2D images, wherein the second gaze direction is represented as a third yaw angle and a third pitch angle in a camera coordinate system; and
associate the second gaze direction of the user with the first gaze zone based on:
the third yaw angle;
the third pitch angle; and
the first Gaussian distribution of the first gaze zone.

4. The apparatus of claim 2, wherein:
the first gaze zone comprises a first top left corner, a first top right corner, a first bottom left corner, and a first bottom right corner;
the one or more first 2D images correspond to a head of the user in a first location;
the one or more processors are configured to cause the apparatus to:
for the head of the user in the first location:
determine a top left corner gaze direction of the user towards the first top left corner, wherein the top left corner gaze direction is represented as a top left corner yaw angle and a top left corner pitch angle in the camera coordinate system;
determine a top right corner gaze direction of the user towards the first top right corner, wherein the top right corner gaze direction is represented as a top right corner yaw angle and a top right corner pitch angle in the camera coordinate system;
determine a bottom left corner gaze direction of the user towards the first bottom left corner, wherein the bottom left corner gaze direction is represented as a bottom left corner yaw angle and a bottom left corner pitch angle in the camera coordinate system;
determine a bottom right corner gaze direction of the user towards the first bottom right corner, wherein the bottom right corner gaze direction is represented as a bottom right corner yaw angle and a bottom right corner pitch angle in the camera coordinate system;
determine an average yaw angle for the user corresponding to the first gaze zone based on the top left corner yaw angle, the top right corner yaw angle, the bottom left corner yaw angle, and the bottom right corner yaw angle; and
determine an average pitch angle for the user corresponding to the first gaze zone based on the top left corner pitch angle, the top right corner pitch angle, the bottom left corner pitch angle, and the bottom right corner pitch angle;
determine the first offset based on a difference between an average first zone yaw angle corresponding to an average head location of the plurality of users and the average yaw angle for the user; and
determine the second offset based on a difference between an average first zone pitch angle corresponding to the average head location of the plurality of users and the average yaw angle for the user.

5. The apparatus of claim 4, wherein the one or more processors are configured to cause the apparatus to:
determine the average head location of the plurality of users;
for the average head location of the plurality of users:
determine a first gaze zone top left corner gaze direction towards the first top left corner, wherein the first gaze zone top left corner gaze direction is represented as a first gaze zone top left corner yaw angle and a first gaze zone top left corner pitch angle in the camera coordinate system;
determine a first gaze zone top right corner gaze direction towards the first top right corner, wherein the first gaze zone top right corner gaze direction is represented as a first gaze zone top right corner yaw angle and a first gaze zone top right corner pitch angle in the camera coordinate system;
determine a first gaze zone bottom left corner gaze direction towards the first bottom left corner, wherein the first gaze zone bottom left corner gaze direction is represented as a first gaze zone bottom left corner yaw angle and a first gaze zone bottom left corner pitch angle in the camera coordinate system; and
determine a first gaze zone bottom right corner gaze direction towards the first bottom right corner, wherein the first gaze zone bottom right corner gaze direction is represented as a first gaze zone bottom right corner yaw angle and a first gaze zone bottom right corner pitch angle in the camera coordinate system;
determine the average first zone yaw angle corresponding to the average head location of the plurality of users based on the first gaze zone top left corner yaw angle, the first gaze zone top right corner yaw angle, the first gaze zone bottom left corner yaw angle, and the first gaze zone bottom right corner yaw angle; and
determine the average first zone pitch angle corresponding to the average head location of the plurality of users based on the first gaze zone top left corner pitch angle, the first gaze zone top right corner pitch angle, the first gaze zone bottom left corner pitch angle, and the first gaze zone bottom right corner pitch angle.

6. The apparatus of claim 1, wherein:
the plurality of gaze directions of the plurality of users are represented as a plurality of second yaw angles and a plurality of second pitch angles in the camera coordinate system; and
the one or more processors are configured to cause the apparatus to:
for each respective gaze direction of each respective user:
adjust the respective second yaw angle of the respective gaze direction by a respective first offset to generate a respective third yaw angle in the camera coordinate system, wherein the respective first offset is associated with the respective user; and
adjust the respective second pitch angle of the respective gaze direction by a respective second offset to generate a respective third pitch angle in the camera coordinate system, wherein the respective second offset is associated with the respective user.

7. The apparatus of claim 6, wherein:
the first gaze zone comprises a first top left corner, a first top right corner, a first bottom left corner, and a first bottom right corner;
the one or more processors are configured to cause the apparatus to:
for a respective head location of each respective user:
determine a respective top left corner gaze direction of the respective user towards the first top left corner, wherein the respective top left corner gaze direction is represented as a respective top left corner yaw angle and a respective top left corner pitch angle in the camera coordinate system;
determine a respective top right corner gaze direction of the respective user towards the first top right corner, wherein the respective top right corner gaze direction is represented as a respective top right corner yaw angle and a respective top right corner pitch angle in the camera coordinate system;
determine a respective bottom left corner gaze direction of the respective user towards the first bottom left corner, wherein the respective bottom left corner gaze direction is represented as a respective bottom left corner yaw angle and a respective bottom left corner pitch angle in the camera coordinate system;
determine a respective bottom right corner gaze direction of the respective user towards the first bottom right corner, wherein the respective bottom right corner gaze direction is represented as a respective bottom right corner yaw angle and a respective bottom right corner pitch angle in the camera coordinate system;
determine a respective average yaw angle for the respective user corresponding to the first gaze zone based on the respective top left corner yaw angle, the respective top right corner yaw angle, the respective bottom left corner yaw angle, and the respective bottom right corner yaw angle; and
determine a respective average pitch angle for the respective user corresponding to the first gaze zone based on the respective top left corner pitch angle, the respective top right corner pitch angle, the respective bottom left corner pitch angle, and the respective bottom right corner pitch angle; and
for each respective user:
determine the respective first offset based on a difference between an average first zone yaw angle corresponding to an average head location of the plurality of users and the respective average yaw angle for the respective user; and
determine the respective second offset based on a difference between an average first zone pitch angle corresponding to the average head location of the plurality of users and the respective average yaw angle for the respective user.

8. The apparatus of claim 6, wherein the one or more processors are configured to cause the apparatus to:
determine a yaw angle mean for a plurality of third yaw angles comprising the respective third yaw angle of each respective user;
determine a pitch angle mean for a plurality of third pitch angles comprising the respective third pitch angle of each respective user;
determine a yaw angle variance for the plurality of third yaw angles;
determine a pitch angle variance for the plurality of third pitch angles; and
determine the first Gaussian distribution of the first gaze zone based on the yaw angle mean, the pitch angle mean, the yaw angle variance, and the pitch angle variance.

9. The apparatus of claim 1, wherein:
the plurality of gaze directions of the plurality of users are represented as a plurality of yaw angles and a plurality of pitch angles in the camera coordinate system; and
the one or more processors are configured to cause the apparatus to:
determine a yaw angle mean for the plurality of yaw angles;
determine a pitch angle mean for the plurality of pitch angles;
determine a yaw angle variance for the plurality of yaw angles;
determine a pitch angle variance for the plurality of pitch angles; and
determine the first Gaussian distribution of the first gaze zone based on the yaw angle mean, the pitch angle mean, the yaw angle variance, and the pitch angle variance.

10. The apparatus of claim 1, wherein the plurality of gaze directions of the plurality of users correspond to at least one of:
a plurality of user heights; or
a plurality of user sitting positions.

11. The apparatus of claim 1, wherein to associate the first gaze direction of the user with the first gaze zone, the one or more processors are configured to cause the apparatus to:
for each respective gaze zone of the plurality of gaze zones, determine a Gaussian response based on:
the first yaw angle;
the first pitch angle; and
a Gaussian distribution of the respective gaze zone; and
associate the first gaze direction of the user with the first gaze zone based on the first gaze zone having a greatest Gaussian response among the plurality of gaze zones.

12. The apparatus of claim 1, wherein to estimate the first gaze direction of the user, the one or more processors are configured to cause the apparatus to:
reconstruct a three-dimensional (3D) face model for the user based on at least one of the one or more first 2D images of the face of the user;
estimate a head pose of the user using the 3D face model;
identify one or more facial landmarks of the user corresponding to one or more eye locations of the user using the 3D face model;
normalize eye image patches associated with the user to generate a fixed-size eye image patch pair using the one or more facial landmarks identified for the user;
process, using a gaze estimation network, the head pose and the fixed-size eye image patch pair to estimate a second gaze direction of the user in a head coordinate system;
estimate a head position of the user using the 3D face model; and
estimate the first gaze direction of the user in the camera coordinate system based on the head position and the second gaze direction of the user in the head coordinate system.

13. A method, comprising:
estimating a first gaze direction of a user based on at least one or more first two-dimensional (2D) images of a face of the user, wherein the first gaze direction is represented as a first yaw angle and a first pitch angle in a camera coordinate system; and
associating the first gaze direction of the user with a first gaze zone among a plurality of gaze zones based on:
the first yaw angle;
the first pitch angle; and
a first Gaussian distribution of the first gaze zone, wherein the first Gaussian distribution is based on a plurality of gaze directions, of a plurality of users, associated with the first gaze zone.

14. The method of claim 13, further comprising:
adjusting the first yaw angle by a first offset to generate a second yaw angle in the camera coordinate system; and
adjusting the first pitch angle by a second offset to generate a second pitch angle in the camera coordinate system,
wherein associating the first gaze direction of the user with the first gaze zone comprises associating the first gaze direction of the user with a first gaze zone based on the second yaw angle and the second pitch angle.

15. The method of claim 14, wherein:
the one or more first 2D images correspond to a head of the user in a first location; and
the method further comprises:
collecting one or more second 2D images of the face of the user corresponding to the head of the user in a second location different from the first location;
estimating a second gaze direction of the user based on at least the one or more second 2D images, wherein the second gaze direction is represented as a third yaw angle and a third pitch angle in a camera coordinate system; and
associating the second gaze direction of the user with the first gaze zone based on:
the third yaw angle;
the third pitch angle; and
the first Gaussian distribution of the first gaze zone.

16. The method of claim 14, wherein:
the first gaze zone comprises a first top left corner, a first top right corner, a first bottom left corner, and a first bottom right corner;
the one or more first 2D images correspond to a head of the user in a first location; and
the method further comprises:
for the head of the user in the first location:
determining a top left corner gaze direction of the user towards the first top left corner, wherein the top left corner gaze direction is represented as a top left corner yaw angle and a top left corner pitch angle in the camera coordinate system;
determining a top right corner gaze direction of the user towards the first top right corner, wherein the top right corner gaze direction is represented as a top right corner yaw angle and a top right corner pitch angle in the camera coordinate system;
determining a bottom left corner gaze direction of the user towards the first bottom left corner, wherein the bottom left corner gaze direction is represented as a bottom left corner yaw angle and a bottom left corner pitch angle in the camera coordinate system;
determining a bottom right corner gaze direction of the user towards the first bottom right corner, wherein the bottom right corner gaze direction is represented as a bottom right corner yaw angle and a bottom right corner pitch angle in the camera coordinate system;
determining an average yaw angle for the user corresponding to the first gaze zone based on the top left corner yaw angle, the top right corner yaw angle, the bottom left corner yaw angle, and the bottom right corner yaw angle; and
determining an average pitch angle for the user corresponding to the first gaze zone based on the top left corner pitch angle, the top right corner pitch angle, the bottom left corner pitch angle, and the bottom right corner pitch angle;
determining the first offset based on a difference between an average first zone yaw angle corresponding to an average head location of the plurality of users and the average yaw angle for the user; and
determining the second offset based on a difference between an average first zone pitch angle corresponding to the average head location of the plurality of users and the average yaw angle for the user.

17. The method of claim 16, further comprising:
determining the average head location of the plurality of users;
for the average head location of the plurality of users:
determining a first gaze zone top left corner gaze direction towards the first top left corner, wherein the first gaze zone top left corner gaze direction is represented as a first gaze zone top left corner yaw angle and a first gaze zone top left corner pitch angle in the camera coordinate system;
determining a first gaze zone top right corner gaze direction towards the first top right corner, wherein the first gaze zone top right corner gaze direction is represented as a first gaze zone top right corner yaw angle and a first gaze zone top right corner pitch angle in the camera coordinate system;
determining a first gaze zone bottom left corner gaze direction towards the first bottom left corner, wherein the first gaze zone bottom left corner gaze direction is represented as a first gaze zone bottom left corner yaw angle and a first gaze zone bottom left corner pitch angle in the camera coordinate system; and
determining a first gaze zone bottom right corner gaze direction towards the first bottom right corner, wherein the first gaze zone bottom right corner gaze direction is represented as a first gaze zone bottom right corner yaw angle and a first gaze zone bottom right corner pitch angle in the camera coordinate system;
determining the average first zone yaw angle corresponding to the average head location of the plurality of users based on the first gaze zone top left corner yaw angle, the first gaze zone top right corner yaw angle, the first gaze zone bottom left corner yaw angle, and the first gaze zone bottom right corner yaw angle; and
determining the average first zone pitch angle corresponding to the average head location of the plurality of users based on the first gaze zone top left corner pitch angle, the first gaze zone top right corner pitch angle, the first gaze zone bottom left corner pitch angle, and the first gaze zone bottom right corner pitch angle.

18. The method of claim 13, wherein:
the plurality of gaze directions of the plurality of users are represented as a plurality of second yaw angles and a plurality of second pitch angles in the camera coordinate system; and
the method further comprises:
for each respective gaze direction of each respective user:
adjusting the respective second yaw angle of the respective gaze direction by a respective first offset to generate a respective third yaw angle in the camera coordinate system, wherein the respective first offset is associated with the respective user; and
adjusting the respective second pitch angle of the respective gaze direction by a respective second offset to generate a respective third pitch angle in the camera coordinate system, wherein the respective second offset is associated with the respective user.

19. The method of claim 18, wherein:
the first gaze zone comprises a first top left corner, a first top right corner, a first bottom left corner, and a first bottom right corner; and
the method further comprises:
for a respective head location of each respective user:
determining a respective top left corner gaze direction of the respective user towards the first top left corner, wherein the respective top left corner gaze direction is represented as a respective top left corner yaw angle and a respective top left corner pitch angle in the camera coordinate system;
determining a respective top right corner gaze direction of the respective user towards the first top right corner, wherein the respective top right corner gaze direction is represented as a respective top right corner yaw angle and a respective top right corner pitch angle in the camera coordinate system;
determining a respective bottom left corner gaze direction of the respective user towards the first bottom left corner, wherein the respective bottom left corner gaze direction is represented as a respective bottom left corner yaw angle and a respective bottom left corner pitch angle in the camera coordinate system; and
determining a respective bottom right corner gaze direction of the respective user towards the first bottom right corner, wherein the respective bottom right corner gaze direction is represented as a respective bottom right corner yaw angle and a respective bottom right corner pitch angle in the camera coordinate system;
determining a respective average yaw angle for the respective user corresponding to the first gaze zone based on the respective top left corner yaw angle, the respective top right corner yaw angle, the respective bottom left corner yaw angle, and the respective bottom right corner yaw angle; and
determining a respective average pitch angle for the respective user corresponding to the first gaze zone based on the respective top left corner pitch angle, the respective top right corner pitch angle, the respective bottom left corner pitch angle, and the respective bottom right corner pitch angle; and
for each respective user:
determining the respective first offset based on a difference between an average first zone yaw angle corresponding to an average head location of the plurality of users and the respective average yaw angle for the respective user; and
determining the respective second offset based on a difference between an average first zone pitch angle corresponding to the average head location of the plurality of users and the respective average yaw angle for the respective user.

20. The method of claim 18, further comprising:
determining a yaw angle mean for a plurality of third yaw angles comprising the respective third yaw angle of each respective user;
determining a pitch angle mean for a plurality of third pitch angles comprising the respective third pitch angle of each respective user;
determining a yaw angle variance for the plurality of third yaw angles;
determining a pitch angle variance for the plurality of third pitch angles; and
determining the first Gaussian distribution of the first gaze zone based on the yaw angle mean, the pitch angle mean, the yaw angle variance, and the pitch angle variance.
